(19) United States
(12) Patent Application Publication
(10) Pub. No.: US 2022/0095549 A1
(43) Pub. Date: Mar. 31, 2022

(54) METHOD FOR MODULATING A CONDITION OF A BIOLOGICAL CELL

(71) Applicant: MERCK PATENT GMBH, DARMSTADT (DE)

(72) Inventors: Werner STOCKUM, Reinheim (DE); Michael SCHABERGER, Griesheim (DE); Stephan DERTINGER, Heidelberg (DE); Nina SIRAGUSA, Frankfurt Am Main (DE); Hiroshi OKURA, Kanagawa (JP)

(73) Assignee: MERCK PATENT GMBH, DARMSTADT (DE)

(21) Appl. No.: 17/423,622

(22) PCT Filed: Jan. 16, 2020
(86) PCT No.: PCT/EP2020/050952

§ 371 Date: Jul. 16, 2021

(30) Foreign Application Priority Data
Jan. 18, 2019 (EP) 19152667.2

(51) Int. Cl. A01G 9/14; C09K 11/02; C09K 11/57; A01G 7/04

(52) U.S. Cl. CPC A01G 9/1438; A01G 7/045; C09K 11/576; C09K 11/025

(57) ABSTRACT

The present invention refers to a method for modulating a condition of a biological cell.

### FIELD OF THE INVENTION

The present invention refers to a method for modulating a condition of a biological cell. The present invention further relates to a composition or foil, a composite layer usable as greenhouse foil, greenhouse, and a process for manufacturing of a thermoplastic foil or sheet,

### BACKGROUND ART

The greenhouse has its own microclimate that it allows to obtain fruit and vegetables out of season. A greenhouse is an architecture with transparent walls and roof made mainly of plastic foil or glass. Many commercial greenhouses are high tech production facilities for vegetables or flowers. The glass greenhouses are filled with equipment including screening installations, heating, cooling, lighting, and may be controlled by a computer to optimize conditions for plant growth. Quantitative studies suggest that the effect of infrared radiative cooling is not negligibly small and may have economic implications in a heated greenhouse. Analysis of issues of near-infrared radiation in a greenhouse with screens of a high coefficient of reflection concluded that installation of such screens reduced heat demand by about 8%, and application of dyes to transparent surfaces was suggested. Advanced plastic foil (e.g. LDPE) with light scattering pigments, or light Composite less-reflective glass, or less effective but cheaper anti-reflective coated simple glass, also produced savings.

Heating or electricity is one of the most considerable costs in the operation of greenhouses, especially in colder climates. The main problem with heating a greenhouse as opposed to a building that has solid opaque walls is the amount of heat lost through the greenhouse covering. Since the coverings need to allow light to filter into the structure, they conversely cannot insulate very well. With traditional plastic greenhouse coverings having an R-value of around 2, a great amount of money is therefore spent to continually replace the heat lost. Most greenhouses, when supplemental heat is needed use natural gas or electric furnaces.

During the day, light enters the greenhouse via the windows and is used by the plants. Some greenhouses are also equipped with grow lights (often LED lights) which are switched on at night to increase the amount of light the plants get, hereby increasing the yield with certain crops.^{[23]}

Plants use the process of photosynthesis to convert light, C0₂ and H₂0 into carbohydrates (sugars). These sugars are used to fuel metabolic processes. The excess of sugars is used for biomass formation. This biomass formation includes stem elongation, increase of leaf area, flowering, fruit formation, etc. The photoreceptor responsible for photosynthesis is chlorophyll.

Two important absorption peaks of chlorophyll a and b are in the red and blue regions, especially from 625-675 nm and from 425-475 nm, respectively. Additionally, there are also other localized peaks at near-UV (300-400 nm) and in the far-red region (700-800 nm). The main photosynthetic activity seems to take place within the wavelength range 400-700 nm. Radiation within this range is called photosynthetically active radiation (PAR).

The use of plastic materials in agriculture provides benefits: plastic covering films and nets can be used to protect plants from adverse weather conditions; plastic mulching films contribute to a more efficient use of water and farm land and to a reduction of the use of chemical weed killers; plastic covering of crops advances or delays harvests. Higher quality and quantity of crop production can be reached applying innovative plastic covering films and nets able to modify the spectral wavelength distribution and quantity of the transmitted solar radiation (“Analysis and Design of Low-density Polyethylene Greenhouse Films”, Briassoulis et al.,Biosystems Engineering (2003) 84(3), pp 303-314; “Experimental tests and technical characteristics of regenerated films from agricultural plastics”, Picuno et al., Polymer Degradation and Stability 97 (2012), pp 1654-1661; “Radiometric properties of photoselective and photoluminescent greenhouse plastic films and their effects on peach and cherry tree growth” Schettini et al., The Journal of Horticultual Science and Biotechnology, vol. 86, 2011-issue 1; “Plastic Nets in Agriculture”, Castellano et al., Applied Engineering in Agriculture, Vol. 24(6) 799-808 (2008); “Airflow through net covered tunnel structure at high wind speeds”, Mistriotis et al., Biosynthesis Engineering 113 (2012) pp 308-317; “Macrophage polarization in pathology”, Sica et al., Cellular and Molecular Life Sciences November 2015, volume 72, Issue 21, pp 4111-4126; “Effects of agrochemicals on the radiometric properties of different anti-UV stabiliyed EVA plastic films”, Schettini et al., Acta horticulturae 2012 no.956).

High intensity lights are often necessary in the greenhouse environment and are indeed a burden with their energy requirement.

Whatever type of lighting used in the greenhouse (Luminescent, HID or LED), there are decisions that are made that can greatly influence energy conservation. With supplemental lighting, the crop will determine at what external light levels the lights need to be turned on, but the time frame that passes at the low light level before this occurs is in the hands of the grower. HID lights, for example, take a large amount of energy to get to full intensity; you do not want to be cycling on and off unnecessarily throughout the day by having the lights react too quickly. Greenhouse lighting is a big contributor to the total energy consumption.

JP 2007-135583 A mentions an organic dye having a peak wavelength at 613 nm and suggestion to use it with a thermoplastic resin as an agriculture film.

A polypropylene film containing an organic dye with peak light emission wavelength at 592 nm is disclosed in WO 1993/009664 A1. JP H09-249773 A mentions an organic dye having peak light wavelength at 592 nm and a suggestion to use it with a polyolefin resin as an agriculture film.

A combination of an ultraviolet light emitting diode, blue, red yellow light emitting diodes for green house light source is disclosed in JP 2001-28947 A.

JP 2004-113160 A discloses a plant growth kit with a light emitting diode light source containing blue and red light emitting diodes.

(Ba,Ca,Sr)₃MgSi₂O₈:Eu²⁺, Mn²⁺ phosphors such as (Ba0.97Eu0.03)₃(Mg0.95Mn0.05)Si₂O₈, (Ba0.735 Sr0.235Eu0.03)₃(Mg0.95Mn0.05) Si₂O₈ with a peak light emission wavelength around 625 nm, and a suggestion to use it as an agricultural lamp is described on Han et al., Journal of luminescence (2014), vol. 148, p 1-5.

### PATENT LITERATURE

1. JP 2007-135583 A

2. WO 1993/009664 A1

3. JP H09-249773A

4. JP 2001-28947A

5. JP 2004-113160A

### NON-PATENT LITERATURE

6. “Analysis of (Ba,Ca,Sr)₃MgSi₂O₈:Eu²⁺, Mn²⁺ phosphors for application in solid state lighting”, Han et al., Journal of luminescence (2014), vol. 148, p 1-5

7. “Analysis and Design of Low-density Polyethylene Greenhouse Films”, Briassoulis et al., Biosystems Engineering (2003) 84(3), pp 303-314;

8. “Experimental tests and technical characteristics of regenerated films from agricultural plastics”, Picuno et al., Polymer Degradation and Stability 97 (2012), pp 1654-1661;

9. “Radiometric properties of photoselective and photoluminescent greenhouse plastic films and their effects on peach and cherry tree growth” Schettini et al., The Journal of Horticultual Science and Biotechnology, vol. 86, 2011-issue 1;

10. “Plastic Nets in Agriculture”, Castellano et al., Applied Engineering in Agriculture, Vol. 24(6) 799-808 (2008);

11. “Airflow through net covered tunnel structure at high wind speeds”, Mistriotis et al., Biosynthesis Engineering 113 (2012) pp 308-317;

12. “Macrophage polarization in pathology”, Sica et al., Cellular and Molecular Life Sciences November 2015, volume 72, Issue 21, pp 4111-4126;

13. “Effects of agrochemicals on the radiometric properties of different anti-UV stabiliyed EVA plastic films”, Schettini et al., Acta horticulturae 2012 no. 956.

### SUMMARY OF THE INVENTION

A process and application for a qualified Greenhouse-foil to achieve energy saving due to enhanced modulating a condition of a biological cell is made available by the present invention. Unexpectedly it was found by these experiments that the plant growing can be enhanced with a Greenhouse foil comprises a sunlight conversion material in the polymer matrix.

There are still more considerable problems for which improvement are desired, as listed below; improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; or controlling of ripening of fruits.

The design of greenhouse should be based upon scientific principles which facilitates controlled environment for the plant growth. The advanced Greenhouse-foil (1) with containing inorganic phosphor is directed for application as cladding material and/or incorporated inorganic phosphor containing shading nets (2) and/or incorporated inorganic phosphor containing light reflector shields (3) and/or incorporated inorganic phosphor containing light reflector tapes (4).

The term “advanced Greenhouse foil” as used herein means any extruded thermoplastics with inorganic phosphor as a sunlight conversion material which provides an optimized wavelength of light that reaches a plant. The advanced Greenhouse foil is the replacement for the state of the art Greenhouse foil without sunlight conversion.

The term “inorganic phosphor” as used herein means any inorganic phosphor formulation that is solid and provides an optimized wavelength of light that reaches a plant. The inorganic phosphor can have any particle size adapted to the application requirements.

Then, it is found that a novel method for modulating a condition of a biological cell by light irradiation from an inorganic phosphor with a light source, preferably the light source is sunlight and/or an artificial light source, wherein the modulating a condition of a biological cell is archived by applying light irradiation of light emitted from said inorganic phosphor comprising the peak maximum light wavelength in the range from 500 nm to 750 nm, wherein the light emitted from the phosphor is obtained by contacting the light from the light source with inorganic phosphor which is incorporated in or onto a polymer and/or glass matrix for manufacturing of film, sheets and pipes.

In a preferred embodiment, the biological cell is a cell of a living organism, more preferably biological cell is a prokaryotic or eukaryotic cell, particularly preferably, the prokaryotic cell is a bacterium or archaea, particularly preferably, the eukaryotic cell is a plant cell, animal cell, fungi cell, slime mould cell, protozoa cell and algae, very particularly preferably the biological cell is a plant cell, most preferably the biological cell is a crop cell or a flower cell.

In another aspect, the invention relates to method modulating a condition of a biological cell by light irradiation with a light source comprising process steps of:

A. Selecting a biological cell for greenhouse cultivation, preferably, the biological cell is a cell of a living organism, more preferably biological cell is a prokaryotic or eukaryotic cell, particularly preferably, the prokaryotic cell is a bacterium or archaea, particularly preferably, the eukaryotic cell is a plant cell, animal cell, fungi cell, slime mould cell, protozoa cell and algae, very particularly preferably the biological cell is a plant cell, most preferably the biological cell is a crop cell or a flower cell;

B. Measurement of the available light spectrum and intention of the light spectrum in the greenhouse from natural sunlight and/or artificial light;

C. Predicting the integrated amount of solar radiation which can modulate a condition of a biological cell during the cultivation, preferably said radiation includes a peak light wavelength in the range from 600 nm or more;

D. Calculating of Red:FarRed (R:FR) ratio for maximum yield increase for responding a biological cell;

E. Selecting inorganic phosphor and/or mixture, concentration of inorganic phosphor, polymer matrix and thickness of the polymer matrix to adjust the R:FR ratio which determines the ratio between active phytochromes (Pfr) and inactive phytochromes (Pr) with maximum yield increase for predetermined environment.

In another aspect, the invention relates to a foil comprising a polymeric substrate and at least one compound incorporated in the polymeric substrate or coated on the polymeric substrate, wherein the compound is one or more of inorganic phosphors in a concentration of 0.5% to about 35% by weight, based on the total weight of the polymeric substrate.

In another aspect, the invention relates to a polymer composition comprising at least one polymer material and one compound, wherein the compound is consisting of one or more of inorganic phosphors in a concentration of 0.5% to about 35% by weight, based on the total weight of the polymer composition.

In another aspect, the present invention also relates to composite layer (1) usable as greenhouse foil comprising a supporting layer (1′) and at least one inorganic phosphor layer (1″), preferably said layer (1″) comprises at least one inorganic phosphor.

In another aspect, the present invention furthermore relates to a greenhouse for modulating a condition of a biological cell by light irradiation from an inorganic phosphor having at least one inorganic phosphor matrix layer (1) as active material for generating intensified wave lengths above 600 nm in the fluorescence spectrum.

In another aspect, the present invention relates to a process for manufacture of a thermoplastic foil or sheet comprising at least one inorganic phosphor comprising the process steps;

i) providing an inorganic phosphor power comprising at least one phosphor,

ii) Extrusion of the Masterbatch with Polyethylengranule with the inorganic phosphor powder, and

iii) Extrusion of the foil with Polyethylen and Masterbatchgranule.

In another aspect, the invention relates to a composition comprising, essentially consisting of, or consisting of, at least a light luminescent material and a pigment.

In another aspect, the invention also relates to a foil comprising at least a light luminescent material and a pigment.

In another aspect, the invention further relates to use of the composition comprising, essentially consisting of, or consisting of, at least a light luminescent material and a pigment, or a foil comprising at least a light luminescent material and a pigment for a modulating a condition of a biological cell by light irradiation and heat management in a greenhouse.

In another aspect, the invention relates to a formulation comprising, essentially consisting of, or a consisting of the composition and a solvent.

In another aspect, the invention relates to an optical medium (FIG. 8-13) comprising the composition.

In another aspect, the invention relates to use of the composition, or the formulation in an optical medium fabrication process.

In another aspect, the present invention furthermore relates to method for preparing the optical medium (FIG. 8-13), wherein the method comprises following steps (a) and (b),

(a) providing the composition, or the formulation in a first shaping, preferably providing the composition onto a substrate or into an inflation moulding machine, and

(b) fixing the matrix material by evaporating a solvent and/or polymerizing the composition by heat treatment or exposing the photosensitive composition under ray of light or a combination of any of these.

In another aspect, the present invention also relates to a light emitting phosphor represented by following general formula (VII),

A₅P₆O₂₅:Mn (VII)

wherein the component “A” stands for at least one cation selected from the group consisting of Si⁴⁺, Ge⁴⁺, Sn⁴⁺, Ti⁴⁺ and Zr⁴⁺, preferably Mn is Mn⁴⁺, more preferably said phosphor is Si₅P₆O₂₅:Mn⁴⁺.

In another aspect, the present invention also relates to a light emitting phosphor represented by following general formula (IX), or (X)

A1B1C1O₆:Mn (IX)

A1=at least one cation selected from the group consisting of Mg²⁺, Ca²⁺, Sr²⁺ and Ba²⁺Zn²⁺, preferably A1 is Ba²⁺;

B1=at least one cation selected from the group consisting of Sc³⁺, Y³⁺, La³⁺, Ce³⁺, B³⁺, Al³⁺ and Ga³⁺, preferably B₁ is Y³⁺;

C1=at least one cation selected from the group consisting of V⁵⁺, Nb⁵⁺ and Ta⁵⁺, preferably C₁ is Ta⁵⁺;

A2B2C2D1O₆:Mn (X)

A2=at least one cation selected from the group consisting of Li⁺, Na⁺, K⁺, Rb⁺ and Cs⁺, preferably A₂ is Na⁺;

B2=at least one cation selected from the group consisting of Sc³⁺, La³⁺, Ce³⁺, B³⁺, Al³⁺ and Ga³⁺, preferably B₂ is La³⁺;

C2=at least one cation selected from the group consisting of Mg²⁺, Ca²⁺, Sr²⁺, Ba²⁺ and Zn²⁺, preferably C₂ is Mg²⁺;

D1=at least one cation selected from the group consisting of Mo⁶⁺ and W⁶⁺, preferably D₁ is W⁶⁺.

In another aspect, the present invention relates to use of the composition, the formulation, the optical medium (FIG. 8-13), or the phosphor, for agriculture or for cultivation of alga, photosynthetic bacteria, and/or phytoplankton.

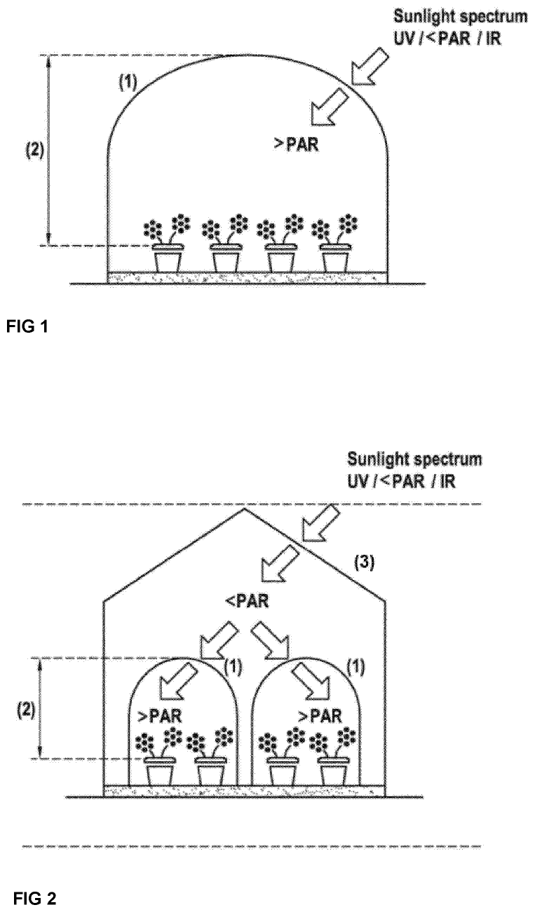

In another aspect, the present invention relates to use of the composition, the formulation, the optical medium (FIG. 8-13), or the phosphor, for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant FIG. 1-7).

In another aspect, the present invention relates to use of an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less,

and a second peak wavelength of light emitted from the inorganic phosphor in the range of 650 nm or more, preferably the first peak wavelength of light emitted from the inorganic phosphor is in the range from 250 nm to 500 nm, and the second peak light emission wavelength is in the range from 650 nm to 1500 nm, more preferably the first peak wavelength of light emitted from the inorganic phosphor is in the range from 300 nm to 500 nm, and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm, for agriculture, or for cultivation of alga, photosynthetic bacteria, and/or phytoplankton.

In another aspect, the present invention relates to use of an inorganic phosphor having a peak wavelength of light emitted from the inorganic phosphor in the range of 650 nm or more, preferably in the range from 650 to 1500 nm, more preferably in the range from 650 to 1000 nm, even more preferably in the range from 650 to 800 nm, furthermore preferably in the range from 650 to 750 nm, much more preferably it is from 660 nm to 730 nm, the most preferably from 670 nm to 710 nm,

and/or at least one inorganic phosphor having a peak wavelength of light emitted from the inorganic phosphor in the range of 500 nm or less, preferably in the range from 250 nm to 500 nm, more preferably in the range from 300 nm to 500 nm, even more preferably in the range from 350 nm to 500 nm, furthermore preferably in the range from 400 nm to 500 nm, much more preferably in the range from 420 nm to 480 nm, the most preferably in the rage from 430 nm to 460 nm,

and/or at least one inorganic phosphor having a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 250 nm to 500 nm,

and the second peak light emission wavelength is in the range from 650 nm to 1500 nm, more preferably the first peak wavelength of light emitted from the inorganic phosphor is in the range from 300 nm to 500 nm,

and the second peak light emission wavelength is in the range from 650 nm to 1000 nm, even more preferably the first peak wavelength of light emitted from the inorganic phosphor is in the range from 350 nm to 500 nm, and the second peak light emission wavelength is in the range from 650 nm to 800 nm, furthermore preferably the first peak wavelength of light emitted from the inorganic phosphor is in the range from 400 nm to 500 nm, and the second peak light emission wavelength is in the range from 650 nm to 750 nm, much more preferably the first peak wavelength of light emitted from the inorganic phosphor is in the range from 420 nm to 480 nm, and the second peak light emission wavelength is in the range from 660 nm to 740 nm, the most preferably the first peak wavelength of light emitted from the inorganic phosphor is in the rage from 430 nm to 460 nm and the second peak wavelength of light emitted from the inorganic phosphor is in the range from 660 nm to 710 nm, for improvement of controlling property of a phytoplankton condition, photosynthetic bacteria and/or alga, preferably acceleration of growth of phytoplankton, photosynthetic bacteria and/or alga; improvement of controlling property of plant condition, preferably controlling of a plant height; controlling of color of fruits; promotion and inhibition of germination; controlling of synthesis of chlorophyll and carotenoids, preferably by blue light; plant growth promotion; adjustment and/or acceleration of flowering time of plants; controlling of production of plant components, such as increasing production amount, controlling of polyphenols content, sugar content, vitamin content of plants; controlling of secondary metabolites, preferably controlling of polyphenols, and/or anthocyanins; controlling of a disease resistance of plants; controlling of ripening of fruits, or controlling of weight of plant.

### DETAILED DESCRIPTION OF THE INVENTION

The term “pigments” stands for materials that are insoluble in an aqueous solution and changes the color of reflected or transmitted light as the result of wavelength-selective absorption and/or reflection, e.g. Inorganic pigments, organic pigments and inorganic-organic hybrid pigments.

The term “luminescent” means spontaneous emission of light by a substance not resulting from heat. It is intended to include both, phosphorescent light emission as well as fluorescent light emission.

Thus, the term “light luminescent material” is a material which can emit either fluorescent light or phosphorescent light.

The term “phosphorescent light emission” is defined as being a spin prohibition light emission from a triplet state or higher spin state (e.g. quintet) of spin multiplicity (2S+1)≥3, wherein S is the total spin angular momentum (sum of all the electron spins).

The term “fluorescent light emission” is a spin allowed light emission from a singlet state of spin multiplicity (2S+1)=1.

The term “wavelength converting material” or briefly referred to as a “converter” means a material that converts light of a first wavelength to light of a second wavelength, wherein the second wavelength is different from the first wavelength. Wavelength converting materials include organic materials and inorganic materials that can achieve photon up-conversion, and organic materials and inorganic materials that can achieve photon down-conversion.

The term “photon down-conversion” is a process which leads to the emission of light at longer wavelength than the excitation wavelength, e.g. by the absorption of one photon leads to the emission of light at longer wavelength.

The term “photon up-conversion” is a process that leads to the emission of light at shorter wavelength than the excitation wavelength, e.g. by the two-photon absorption (TPA) or Triplet-triplet annihilation (TTA), wherein the mechanisms for photon up-conversion are well known in the art.

The term “organic material” means a material of organometallic compounds and organic compounds without any metals or metal ions.

The term “organometallic compounds” stands for chemical compounds containing at least one chemical bond between a carbon atom of an organic molecule and a metal, including alkaline, alkaline earth, and transition metals, e.g. Alq₃, LiQ, Ir(ppy)₃.

The inorganic materials include phosphors and semiconductor nanoparticles.

Phosphor

A “phosphor” is a fluorescent or a phosphorescent inorganic material (inorganic phosphor) which contains one or more light emitting centers. The light emitting centers are formed by activator elements such as e.g. atoms or ions of rare earth metal elements, for example La, Ce, Pr, Nd, Pm, Sm, Eu, Gd, Tb, Dy, Ho, Er, Tm, Yb and Lu, and/or atoms or ions of transition metal elements, for example Cr, Mn, Fe, Co, Ni, Cu, Ag, Au and Zn, and/or atoms or ions of main group metal elements, for example Na, Tl, Sn, Pb, Sb and Bi. Examples of suitable phosphors include phosphors based on garnet, silicate, orthosilicate, thiogallate, sulfide, nitride, silicon-based oxynitride, nitridosilicate, nitridoaluminumsilicate, oxonitridosilicate, oxonitridoaluminumsilicate and rare earth doped sialon. Phosphors within the meaning of the present application are materials which absorb electromagnetic radiation of a specific wavelength range, preferably blue and/or ultraviolet (UV) electromagnetic radiation and convert the absorbed electromagnetic radiation into electromagnetic radiation having a different wavelength range, preferably visible (VIS) light such as violet, blue, green, yellow, orange, or red light, or the near infrared light (NIR).

Here, the term “UV” is electromagnetic radiation with a wavelength from 100 nm to 389 nm, shorter than that of visible light but longer than X-rays.

The term “VIS” is electromagnetic radiation with a wavelength from 390 nm to 700 nm.

The term “NIR” is electromagnetic radiation with a wavelength from 701 nm to 1,000 nm.

The term “semiconductor nanoparticle” in the present application denotes a crystalline nanoparticle which consists of a semiconductor material. Semiconductor nanoparticles are also referred to as quantum materials in the present application. They represent a class of nanomaterials with physical properties that are widely tunable by controlling particle size, composition and shape. Among the most evident size dependent property of this class of materials is the tunable fluorescence emission. The tunability is afforded by the quantum confinement effect, where reducing particle size leads to a “particle in a box” behavior, resulting in a blue shift of the band gap energy and hence the light emission. For example, in this manner, the emission of CdSe nanocrystals can be tuned from 660 nm for particles of diameter of ˜6.5 nm, to 500 nm for particles of diameter of ˜2 nm. Similar behavior can be achieved for other semiconductors when prepared as nanocrystals allowing for broad spectral coverage from the UV (using ZnSe, CdS for example) throughout the visible (using CdSe, InP for example) to the near-IR (using InAs for example).

Semiconductor nanoparticles may have an organic ligand on the outermost surface of the nanoparticles.

The phosphor materials can be over coated by silicon dioxide.

The term “radiation-induced emission efficiency” should also be understood in this connection, i.e. the phosphor absorbs radiation in a certain wavelength range and emits radiation in another wavelength range with a certain efficiency. The term “shift of the emission wavelength” is taken to mean that a phosphor emits light at a different wavelength compared with another, i.e. shifted towards a shorter or longer wavelength.

A wide variety of phosphors come into consideration for the present invention, such as, for example, metal-oxide phosphors, silicate and halide phosphors, phosphate and halophosphate phosphors, borate and borosilicate phosphors, aluminate, gallate and alumosilicate phosphors, phosphors, sulfate, sulfide, selenide and telluride phosphors, nitride and oxynitride phosphors and SiAlON phosphors.

In some embodiments of the present invention, the phosphor is selected from the group consisting of metal-oxide phosphors, silicate and halide phosphors, phosphate phosphors, borate and borosilicate phosphors, aluminate, gallate and alumosilicate phosphors, sulfate, sulfide, selenide and telluride phosphors, nitride and oxynitride phosphors and SiAlON phosphors, preferably, it is a metal oxide phosphor, more preferably it is a Mn activated metal oxide phosphor or a Mn activated phosphate based phosphor, even more preferably it is a Mn activated metal oxide phosphor.

According to the present invention, in a preferable embodiment, phosphors having better peak emission intensity can be used preferably to have a stronger light wavelength of light emission to modulate a condition of a crop, plankton, and/or a bacterium by light irradiation more efficiently.

To obtain an improved light emission from the inorganic phosphor, known treatment can be applied if it is desired. For example, subjecting a low temperature annealing for Mg₂TiO₄:Mn⁴⁺ (MTO) or similar inorganic phosphor like described in

Ceramics International, 1994, 20, 111, American Mineralogist, 1995, 80, 885, Journal of Materials Chemistry C, 2013, 1, 4327, can be applied preferably. or an inorganic phosphor subjected a treatment showing improved light emission can be used preferably.

Preferred metal-oxide phosphors are arsenates, germanates, halogermanates, indates, lanthanates, niobates, scandates, stannates, tantalates, titanates, vanadates, halovanadates, phosphovanadates, yttrates, zirconates, molybdate and tungstate.

Even more preferably, it is a metal oxide phosphor, more preferably it is a Mn activated metal oxide phosphor or a Mn activated phosphate-based phosphor, even more preferably it is a Mn activated metal oxide phosphor.

Thus, in some embodiments of the present invention, said inorganic phosphor is selected from the group consisting of metal oxides, silicates and halosilicates, phosphates and halophosphates, borates and borosilicates, aluminates, gallates and alumosilicates, molybdates and tungstates, sulfates, sulfides, selenides and tellurides, nitrides and oxynitrides, SiAlONs, halogen compounds and oxy compounds, such as preferably oxysulfides or oxychlorides phosphors, preferably, it is a metal oxide phosphor, more preferably it is a Mn activated metal oxide phosphor or a Mn activated phosphate based phosphor, even more preferably it is a Mn activated metal oxide phosphor.

For example, the inorganic phosphor is selected from the group consisting of Al2O3:Cr³⁺, Y3Al5O12:Cr³⁺, MgO:Cr³⁺, ZnGa2O4:Cr³⁺, MgAl2O4:Cr³⁺, Gd3Ga5O12:Cr³⁺, LiAl5O8:Cr³⁺, MgSr3Si2O8:Eu²⁺, Mn²⁺, Sr3MgSi2O8:Mn⁴⁺, Sr2MgSi2O7:Mn⁴⁺, SrMgSi2O6:Mn⁴⁺, BaMg6Ti6O19:Mn⁴⁺, Mg8Ge2O11F2:Mn⁴⁺, Mg2TiO4:Mn⁴⁺, Y2MgTiO6:Mn⁴⁺, Li2TiO3:Mn⁴⁺, K2SiF6:Mn⁴⁺, K3SiF7:Mn⁴⁺, K2TiF6:Mn⁴⁺, K2NaAlF6:Mn⁴⁺, BaSiF6:Mn⁴⁺, CaAl12O19:Mn⁴⁺, MgSiO3:Mn²⁺, Si5P6O25:Mn⁴⁺, NaLaMgWO6:Mn⁴⁺, Ba2YTaO6:Mn⁴⁺, ZnAl2O4:Mn²⁺, CaGa2S4:Mn²⁺, CaAlSiN3:Eu²⁺, SrAlSiN3:Eu²⁺, Sr2Si5N8:Eu²⁺, SrLiAlN4:Eu²⁺, CaMgSi2O6:Eu²⁺, Sr2MgSi2O7:Eu²⁺, SrBaMgSi2O7:Eu²⁺, Ba3MgSi2O8:Eu²⁺, LiSrPO₄:Eu²⁺, LiCaPO₄:Eu²⁺, NaSrPO₄:Eu²⁺, KBaPO4:Eu²⁺, KSrPO4:Eu²⁺, KMgPO4:Eu²⁺, □-Sr2P2O7:Eu²⁺, □-Ca2P2O7:Eu²⁺, Mg3(PO4)2:Eu²⁺, Mg3Ca3(PO4)4:Eu²⁺, BaMgAl10O17:Eu²⁺, SrMgAl10O17:Eu²⁺, AlN:Eu²⁺, Sr5(PO4)3Cl:Eu²⁺, NaMgPO4 (glaserite):Eu²⁺, Na3Sc2(PO4)3:Eu²⁺, LiBaBO3:Eu²⁺, SrAlSi4N7:Eu²⁺, Ca2SiO4:Eu²⁺, NaMgPO4:Eu²⁺, CaS:Eu²⁺, Y2O3:Eu³⁺, YVO4:Eu³⁺, LiAlO2:Fe³⁺, LiAl5O8:Fe³⁺, NaAlSiO4:Fe³⁺, MgO:Fe³⁺, Gd3Ga5O12:Cr³⁺,Ce³⁺, (Ca, Ba, Sr)2MgSi2O7:Eu,Mn, CaMgSi2O6:Eu²⁺,Mn²⁺, NaSrBO3:Ce³⁺, NaCaBO3:Ce³⁺, Ca3(BO3)2:Ce³⁺, Sr3(BO3)2:Ce³⁺, Ca3Y(GaO)3(BO3)4:Ce³⁺, Ba3Y(BO3)3:Ce³⁺, CaYAlO4:Ce³⁺, Y2SiO5:Ce³⁺, YSiO2N:Ce³⁺, Y5(SiO4)3N:Ce³⁺, Ca₂Al3O6FGd3Ga5O12:Cr³⁺,Ce³⁺, ZnS, InP/ZnS, CuInS₂, CuInSe₂, CuInS₂/ZnS, carbon/graphen quantum dots and a combination of any of these as described in the second chapter of Phosphor handbook (Yen, Shinoya, Yamamoto).

As one embodiment of the invention, a phosphor or its denaturated (e.g., degraded) substance which less harms animals, plants and/or environment (e.g., soil, water) is desirable.

Thus, one embodiment of the invention, the phosphor is nontoxic phosphors, preferably it is edible phosphors, more preferably as edible phosphors, MgSiO₃:Mn²⁺, MgO:Fe³⁺, CaMgSi₂O₆:Eu²⁺, Mn²⁺ are useful According to the present invention the term “edible” means safe to eat, fit to eat, fit to be eaten, fit for human consumption.

In some embodiments, as a phosphate-based phosphor, a new light emitting phosphor represented by following general formula (VII) which can exhibit deep red-light emission, preferably with a sharp emission around 700 nm under excitation light of 300 to 400 nm, which are suitable to promote plant growth, can be used preferably.

A5P6O25:Mn (VII)

wherein the component “A” stands for at least one cation selected from the group consisting of Si⁴⁺, Ge⁴⁺, Sn⁴⁺, Ti4+ and Zr⁴⁺.

Or the phosphor can be represented by following chemical formula (VII′).

(A1-xMnx)₅P₆O₂₅ (VII′)

The component A stands for at least one cation selected from the group consisting of Si⁴⁺, Ge⁴⁺, Sn⁴⁺, Ti4+ and Zr⁴⁺ preferably A is Si⁴⁺; 0<x≤0.5, preferably 0.05<x≤0.4.

In a preferred embodiment of the present invention, Mn of formula (VII) is Mn⁴⁺.

In a preferred embodiment of the present invention, the phosphor represented by chemical formula is Si₅P₆O₂₅:Mn⁴⁺.

Said phosphor represented by chemical formula (VII) or (VII′) can be fabricated by the following method comprising at least the following steps (w) and (x); (w) mixing a source of the component A in the form of an oxide; a source of the activator selected from one or more members of the group consisting of MnO₂, MnO, MnCO₃, Mn(OH)₂, MnSO₄, Mn(NO₃)₂, MnCl₂, MnF₂, Mn(CH₃COO)₂and hydrates of MnO₂, MnO, MnCO₃, Mn(OH)₂, MnSO₄, Mn(NO₃)₂, MnCl₂, MnF₂, Mn(CH₃COO)₂; and at least one material selected from the group consisting of inorganic alkali, alkaline-earth, ammonium phosphate and hydrogen phosphate, preferably the materials is ammonium dihydrogen phosphate, in a molar ratio of A:Mn:P=5x:5(1−x):6, wherein 0<x≤0.5, preferably 0.01<x≤0.4; more preferably 0.05<x≤0.1, to get a reaction mixture, (x) subjecting said mixture(s) to calcination at the temperature in the range from 600 to 1.500° C., preferably in the range from 800 to 1,200° C., more preferably in the range from 900 to 1,100° C.

As a mixer, any publicly known powder mixing machine can be used preferably in step (w).

In a preferred embodiment of the present invention, said calcination step (x) is carried out under atmospheric pressure in the presence of oxygen, more preferably under air condition.

In a preferred embodiment of the present invention, said calcination step (x) is carried out for the time at least one hour, preferably in the range from 1 hour to 48 hours, more preferably it is from 6 hours to 24 hours, even more preferably from 10 hours to 15 hours.

After the time period of step (X), the calcinated mixture is cooled down to room temperature.

In a preferred embodiment of the present invention, a solvent is added in step (w) to get a better mixture condition. Preferably said solvent is an organic solvent, more preferably it is selected from one or more members of the group consisting of alcohols such as ethanol, methanol, ipropan-2-ol, butan-1-ol; ketones such as acetone, 2-hexanone, butanone, ethyl isopropyl ketone.

In a preferred embodiment of the present invention, the method further comprises following step (y) after step (w) before step (x): (y) subjecting the mixture from step (w) to pre-calcination at the temperature in the range from 100 to 500° C., preferably in the range from 200 to 400° C., even more preferably from 250 to 350° C.

Preferably it is carried out under atmospheric pressure and in the presence of oxygen, more preferably under air condition.

In a preferred embodiment of the present invention, said calcination step (y) is carried out for the time at least 1 hour, preferably from 1 hour to 24 hours, more preferably in the range from 1 hour to 15 hours, even more preferably it is from 3 hours to 10 hours, furthermore preferably from 5 hours to 8 hours.

After the time period, pre-calcinated mixture is cooled down to a room temperature preferably.

In a preferred embodiment of the present invention, the method additionally comprises following step (w′) after pre-calcination step (y), (w′) mixing a mixture obtained from step (y) to get a better mixing condition of the mixture.

As a mixer, any publicly known powder mixing machine can be used preferably in step (w′).

In a preferred embodiment of the present invention, the method further comprises following step (z) before step (x) after step (w), preferably after step (w′), (z) molding said mixture from step (w) or (y) into a compression molded body by a molding apparatus.

In a preferred embodiment of the present invention, the method optionally comprises following step (v) after step (x), (v) grinding obtained material. As a molding apparatus, a publicly known molding apparatus can be used preferably.

In some embodiments, as a metal oxide phosphor, another new light emitting phosphor represented by following general formula (VIII), (IX) or D₁=at least one cation selected from the group consisting of Mo⁶⁺ and W⁶⁺, preferably D₁ is W⁶⁺.

In a preferred embodiment of the present invention, Mn is Mn⁴⁺, more preferably, the phosphor represented by chemical formula (X) is NaLaMgWO₆:Mn⁴⁺ and the phosphor represented by chemical formula (IX) Ba₂YTaO₆:Mn⁴⁺.

Said phosphor represented by chemical formula (VIII) or (IX) can be fabricated by the following method comprising at least the following steps (w″) and (x′);

(w″) mixing sources of components A₁, B₁, C₁, or A₂, B₂, C₂, and D₁ in the form of solid oxides and/or carbonates; a source of Mn activator selected from one or more members of the group consisting of MnO₂, MnO, MnCO₃, Mn(OH)₂, MnSO₄, Mn(NO₃)₂, MnCl₂, MnF₂, Mn(CH₃COO)₂ and hydrates of MnO₂, MnO, MnCO₃, Mn(OH)₂, MnSO₄, Mn(NO₃)₂, MnCl₂, MnF₂, Mn(CH₃COO)₂; in a molar ratio of either A₁:B₁:C₁:Mn=2:1:(1−x):x or A₂:B₂:C₂:D₁:Mn=1:1:1:(1−y):y (0<y≤0.5); wherein 0<x≤0.5, 0<y≤0.5, preferably 0.01<x≤0.4, 0.01<y≤0.4; more preferably 0.05<x≤0.1, 0.05<y≤0.1; to get a reaction mixture, (x′) subjecting said mixture to calcination at the temperature in the range from 1,000 to 1,600° C., preferably in the range from 1,100 to 1,500° C., more preferably in the range from 1,200 to 1,400° C.

Preferably, when preparing phosphors according to general formula (IX) mixtures are preferred comprising component Ai in the form of their oxides (MgO, ZnO) or carbonates (CaCO₃, SrCO₃, BaCO₃), and the remaining components B₁, C₁ an Mn in the form of their oxides (Sc₂O₃, Y₂O₃, La₂O₃, Ce₂O₃, B₂O₃, Al₂O₃, Ga₂O₃ on one hand and V₂O₅, Nb₂O₅, Ta₂O₅ and MnO₂ on the other). In case of lanthanum oxide, it is advantageous to pre-heat the material at 1,200° C. for 10 hours.

Preferably when preparing phosphors according to general formula (X) mixtures are preferred comprising component A₂ and C₂ in the form of their oxides (MgO, ZnO) or carbonates (Li₂CO₃, Na₂CO₃, K₂CO₃, Rb₂CO₃, Cs₂CO₃, CaCO₃, SrCO₃, BaCO₃), and the remaining components B₂, D₂ and Mn in the form of their oxides (Sc₂O₃, La₂O₃, Ce₂O₃, B₂O₃, Al₂O₃, Ga₂O₃ on one hand and MoO₃, WO₃ and MnO₂ on the other). As a mixer, any publicly known powder mixing machine can be used preferably in step (w).

In a preferred embodiment of the present invention, said calcination step (x′) is carried out under atmospheric pressure in the presence of oxygen, more preferably under air condition.

In a preferred embodiment of the present invention, said calcination step (x′) is carried out for the time at least one hour, preferably in the range from 1 hour to 48 hours, more preferably it is from 6 hours to 24 hours, even more preferably from 10 hours to 15 hours. After the time period of step (x′), the calcinated mixture is cooled down to room temperature.

In a preferred embodiment of the present invention, a solvent is added in step (w″) to get a better mixture condition. Preferably said solvent is an organic solvent, more preferably it is selected from one or more members of the group consisting of alcohols such as ethanol, methanol, ipropan-2-ol, butan-1-ol; ketones such as acetone, 2-hexanone, butanone, ethyl isopropyl ketone.

In a preferred embodiment of the present invention, the method further comprises following step (y′) after step (w″) before step (x′):

(y′) subjecting the mixture from step (w″) to pre-calcination at the temperature in the range from 100 to 500° C., preferably in the range from 200 to 400° C., even more preferably from 250 to 350° C. Preferably it is carried out under atmospheric pressure and in the presence of oxygen, more preferably under air condition.

In a preferred embodiment of the present invention, said calcination step (y′) is carried out for the time at least 1 hour, preferably from 1 hour to 24 hours, more preferably in the range from 1 hour to 15 hours, even more preferably it is from 3 hours to 10 hours, furthermore preferably from 5 hours to 8 hours.

After the time period, pre-calcinated mixture is cooled down to a room temperature preferably.

In a preferred embodiment of the present invention, the method additionally comprises following step (w′″) after pre-calcination step (y′), (w′″) mixing a mixture obtained from step (y′) to get a better mixing condition of the mixture.

As a mixer, any publicly known powder mixing machine can be used preferably in step (w′″).

In a preferred embodiment of the present invention, the method further comprises following step (z′) before step (x′) after step (w″), preferably after step (w′″),

(z′) molding said mixture from step (w) or (y) into a compression molded body by a molding apparatus.

In a preferred embodiment of the present invention, the method optionally comprises following step (v′) after step (x′), (v′) grinding obtained material, As a molding apparatus, a publicly known molding apparatus can be used preferably.

In some embodiments of the present invention, the inorganic phosphors can emit a light having the peak wavelength of light emitted from the inorganic phosphor in the range from 660 nm to 710 nm.

Without wishing to be bound by theory, it is believed that the inorganic phosphor having at least one light absorption peak wavelength in UV and/or purple light wavelength region from 300 nm to 430 nm may keep harmful insects off plants.

Therefore, in some embodiments of the present invention, the inorganic phosphor can have at least one light absorption peak wavelength in UV and or purple light wavelength reason from 300 nm to 430 nm.

In some embodiments of the present invention, from the viewpoint of improved plant growth and improved homogeneous of blue and red (or infrared) light emission from the composition or from the light converting sheet, an inorganic phosphor having a first peak wavelength of light emitted from the inorganic phosphor in the range from 400 nm to 500 nm and a second peak wavelength of light emitted from the inorganic phosphor from 650 nm to 750 nm can be used preferably.

More preferably, the inorganic phosphor having the first peak wavelength of light emitted from the inorganic phosphor is in the range from 430 nm to 490 nm, and the second peak light emission wavelength is in the range from 660 nm to 740 nm, more preferably the first peak wavelength of light emitted from the inorganic phosphor is 450 nm and the second peak wavelength of light emitted from the inorganic phosphor is in the range from 660 nm to 710 nm, is used.

Preferably, said at least one inorganic phosphor is a plurality of inorganic phosphor having the first and second peak wavelength of light emitted from the inorganic phosphor, or a plurality of inorganic phosphor having the first and second peak wavelength of light emitted from the inorganic phosphor, or a combination of these.

It is believed that the Mn⁴⁺ activated metal oxide phosphors, Mn, Eu activated metal oxide phosphors, Mn²⁺ activated metal oxide phosphors, Fe³⁺ activated metal oxide phosphors can be used preferably from the viewpoint of environmental friendly since these phosphors do not create Cr⁶⁺ during synthesis procedure.

Without wishing to be bound by theory, it is believed that the Mn₄₊ activated metal oxide phosphors are very useful for plant growth, since it shows narrow full width at half maximum (hereafter “FWHM”) of the light emission, and have the peak absorption wavelength in UV and green wavelength region such as 350 nm and 520 nm, and the emission peak wavelength is in near infrared ray region such as from 650 nm to 730 nm. More preferably, it is from 670 nm to 710 nm.

In other words, without wishing to be bound by theory, it is believed that the Mn⁴⁺ activated metal oxide phosphors can absorb the specific UV light which attracts insects, and green light which does not give any advantage for plant growth, and can convert the absorbed light to longer wavelength in the range from 650 nm to 750 nm, preferably it is from 660 nm to 740 nm, more preferably from 660 nm to 710 nm, even more preferably from 670 nm to 710 nm, which can effectively accelerate plant growth. From that point of view, even more preferably, the inorganic phosphor can be selected from Mn activated metal oxide phosphors.

In a further preferred embodiment of the present invention, the inorganic phosphor is selected from one or more of Mn activated metal oxide phosphors or Mn activated phosphate-based phosphors represented by following formulae (I) to (VI),

AxByOz:Mn⁴⁺ (I)

wherein A is a divalent cation and is selected from one or more members of the group consisting of Mg²⁺, Zn²⁺, Cu²⁺, Co²⁺, Ni²⁺, Fe²⁺, Ca²⁺, Mn²⁺, Ce²⁺; Sr²⁺, Ba²⁺, and Sn²⁺; B is a tetravalent cation and is Ti³⁺, Zr³⁺ or a combination of these; x≥1; y≥0; (x+2y)=z, preferably A is selected from one or more members of the group consisting of Mg²⁺, Ca²⁺, Sr²⁺, Ba²⁺, Zn²⁺, B is Ti³⁺, Zr³⁺, or a combination of Ti³⁺, and Zr³⁺, x is 2, y is 1, z is 4, more preferably, formula (I) is Mg₂TiO₄:Mn⁴⁺;

XaZbOc:Mn⁴⁺ (II)

wherein X is a monovalent cation and is selected from one or more members of the group consisting of Li⁺, Na⁺, K⁺, Ag⁺ and Cu⁺; Z is a tetravalent cation and is selected from the group consisting of Ti³⁺ and Zr³⁺; b≥0; a≥1; (0.5a+2b)=c, preferably X is Li+, Na+ or a combination of these, Z is Ti³⁺, Zr³⁺ or a combination of these a is 2, b is 1, c is 3, more preferably formula (II) is Li₂TiO₃:Mn⁴⁺;

DdEeOf:Mn⁴⁺ (III)

wherein D is a divalent cation and is selected from one or more members of the group consisting of Mg²⁺, Zn²⁺, Cu²⁺, Co²⁺, Ni²⁺, Fe²⁺, Ca²⁺, Mn²⁺, Ce²⁺; Sr²⁺, Ba²⁺, and Sn²⁺; E is a trivalent cation and is selected from the group consisting of Al³⁺, Ga³⁺, Lu³⁺, La³⁺ and In³⁺; e≥10; d≥0; (d+1.5e)=f, preferably D is Ca²⁺, Sr²⁺, Ba²⁺ or a combination of any of these, E is Al³⁺, Gd³⁺ or a combination of these, d is 1, e is 12, f is 19, more preferably formula (III) is CaAl₁₂O₁₉:Mn⁴⁺;

DgEhOi:Mn⁴⁺ (IV)

wherein D is a trivalent cation and is selected from one or more members of the group consisting of Al³⁺, Ga³⁺, Lu³⁺, Sc³⁺, La³⁺ and In³⁺; E is a trivalent cation and is selected from the group consisting of Al³⁺, Ga³⁺, Lu³⁺, Sc³⁺, La³⁺ and In³⁺; h≥0; a≥g; (1.5g+1.5h)=I, preferably D is La³⁺, E is Al³⁺, Gd³⁺ or a combination of these, g is 1, h is 12, i is 19, more preferably formula (IV) is LaAlO₃:Mn⁴⁺;

GⱼJₖLₗOₘ:Mn⁴⁺ (V)

wherein G is a divalent cation and is selected from one or more members of the group consisting of Mg²⁺, Zn²⁺, Cu²⁺, Co²⁺, Ni²⁺, Fe²⁺, Ca²⁺2+, Mn²⁺, Ce²⁺; and Sn2+; J is a trivalent cation and is selected from the group consisting of Y³⁺, Al³⁺, Ga³⁺, Lu³⁺, Sc³⁺, La³⁺ and In³⁺; L is a trivalent cation and is selected from the group consisting of Al³⁺, Ga³⁺, Lu³⁺, Sc³⁺, La³⁺ and In³⁺; l≥0; k≥0; j≥0; (j+1.5k+1.5l)=m, preferably G is selected from Ca2+, Sr2+, Ba2+ or a combination of any of these, J is Y³⁺, Lu³⁺ or a combination of these, L is Al³⁺, Gd³⁺ or a combination of these, j is 1, k is 1, l is 1, m is 4, more preferably it is CaYAlO₄:Mn⁴⁺;

MnQoRpOq:Eu,Mn (VI)

wherein M and Q are divalent cations and are, independently or dependently of each other, selected from one or more members of the group consisting of Mg²⁺, Zn²⁺, Cu²⁺, Co²⁺, Ni²⁺, Fe²⁺, Ca²⁺2+, Mn²⁺, Ce²⁺;

R is Ge³⁺, Si³⁺, or a combination of these; n≥1; o≥0; p≥1; (n+o+2.0p)=q, preferably M is Ca²⁺,

Q is Mg²⁺, Ca²⁺, Zn²⁺ or a combination of any of these,

R is Si³⁺, n is 1, o is 1, p is 2, q is 6, more preferably it is CaMgSi₂O₆:Eu²⁺, Mn²⁺;

A₅P₆O₂₅:Mn⁴⁺ (VII)

wherein the component “A” stands for at least one cation selected from the group consisting of Si⁴⁺, Ge⁴⁺, Sn⁴⁺, Ti⁴⁺ and Zr⁴⁺;

A₁₂B₁C₁O₆:Mn₄₊ (IX)

A₁=at least one cation selected from the group consisting of Mg²⁺, Ca²⁺, Sr²⁺ and Ba²⁺Zn²⁺, preferably A₁ is Ba²⁺;

B₁=at least one cation selected from the group consisting of Sc³⁺, Y³⁺, La³⁺, Ce³⁺, B³⁺, Al³⁺ and Ga³⁺, preferably B₁ is Y³⁺;

C1=at least one cation selected from the group consisting of V⁵⁺, Nb⁵⁺ and Ta⁵⁺, preferably C1 is Ta⁵⁺; and

A2B2C2D1O₆:Mn⁴⁺ (X)

A2=at least one cation selected from the group consisting of Li⁺, Na⁺, K⁺, Rb⁺ and Cs⁺, preferably A2 is Na⁺;

B2=at least one cation selected from the group consisting of Sc³⁺, La³⁺, Ce³⁺, B³⁺, Al³⁺ and Ga³⁺, preferably B2 is La³⁺;

C₂=at least one cation selected from the group consisting of Mg²⁺, Ca²⁺, Sr²⁺, Ba²⁺ and Zn²⁺, preferably C₂ is Mg²⁺;

D₁=at least one cation selected from the group consisting of Mo₆₊ and W⁶⁺, preferably D₁ is W⁶⁺.

A Mn activated metal oxide phosphor represented chemical formula (VI) is more preferable since it emits a light with a first peak wavelength of light emitted from the inorganic phosphor in the range of 500 nm or less, and a second peak wavelength of light emitted from the inorganic phosphor in the range of 650 nm or more, preferably the first peak wavelength of light emitted from the inorganic phosphor is in the range from 400 nm to 500 nm, and the second peak light emission wavelength is in the range from 650 nm to 750 nm, more preferably the first peak wavelength of light emitted from the inorganic phosphor is in the range from 420 nm to 480 nm, and the second peak light emission wavelength is in the range from 660 nm to 740 nm, even more preferably the first peak wavelength of light emitted from the inorganic phosphor is in the rage from 430 nm to 460 nm and the second peak wavelength of light emitted from the inorganic phosphor is in the range from 660 nm to 710 nm.

In a preferred embodiment of the present invention, said phosphor is a Mn activated metal oxide phosphor or a phosphate-based phosphor represented by chemical formula (I), (VII), (IX) or (X).

In some preferred embodiments of the present invention, the inorganic phosphor can be a Mn activated metal oxide phosphor selected from the group consisting of Mg₂TiO₄:Mn⁴⁺, Li₂TiO₃:Mn⁴⁺, CaAl₁₂O₁₉:Mn⁴⁺, LaAlO₃:Mn⁴⁺, CaYAlO₄:Mn⁴⁺, CaMgSi₂O₆:Eu²⁺, Mn²⁺, and a combination of any of these.

In another aspect, the present invention furthermore relates to method comprising at least applying the formulation, to at least one portion of a plant.

In another aspect, the present invention furthermore relates to modulating a condition of a plant, comprising at least following step (C),

(C) providing the optical medium (100), between a light source and a plant, or between a light source and a phytoplankton, or

providing the optical medium (100), over a ridge in a field or over a surface of planter, preferably said planter is a nutrient film technique hydroponics system or a deep flow technique hydroponics system to control plant growth.

In another aspect, the present invention also relates to method for preparing the optical device (200, wherein the method comprises following step (A);

(A) providing the optical medium (100) in an optical device (200). In another aspect, the present invention further relates to a plant obtained or obtainable by the method.

In another aspect, the present invention furthermore relates to a container comprising at least one plant.

Further advantages of the present invention will become evident from the following detailed description.

In a particular embodiment the inorganic phosphor is extruded with a thermoplastics for greenhouse-foil processing, wherein the polymer matrix is selected from one or more members of the group of Polyethen (PE), Polypropen (PP), Polystyrol (PS), Polyvinylchlorid (PVC), Polyacrylnitril (PAN), Polyamide (PA), Polyester (PES), and Polyacrylate (PAN).

The polymer matrix may be contained in an amount of from 50% to 99.5% by weight, preferably in an amount of from 85 to 98% by weight, based on the total amount of the medium.

In a particular embodiment the inorganic phosphor is combined with suitable transparent polymers and AgNW (Silvernanowires) or CNT (Carbon Nano Tubes) to form uniform conductive continuous films, which are optically homogeneous and of controllable thickness, which is thin enough to be still transparent over technologically relevant regions of the electromagnetic spectrum of solar light. Suitable polymers for the preparation of these films include but are not limited to polymers selected from the group poly(3-octylthiophene) (P3OT), poly(3-hexyl-thiophene) polymer (P3HT), poly(3,4-ethylene dioxythiophene), or other polythiophene derivatives and polyanilines and other electron donor polymers or combinations of polymers like poly[2-methoxy-5-(3′,7′-dimethyloctyloxy)1,4-phenylene vinylene] (MDMO-PPV)/1-(3-methoxycarbonyl)-propyl-1-phenyl)[6,6]C₆₁ (PCBM); poly(3-hexyl-thiophene) polymer (P3HT)/(PCBM); poly(3,4-ethylene dioxythiophene)/poly(styrene sulfonate) (PEDOT/PSS). These films are suitable to increase efficiency of flexible photovoltaic devices due to wavelength shift of the sunlight-spectrum [M. W. Rowell. et al., applied Physics Letters 88, 233506(2006)].

In a most preferred embodiment the extruded plastic foil comprises a dispersion agent. The dispersion agent may be contained in an amount of from 0.1 to 15% by weight, preferably in an amount of from 0.5 to 8% by weight, based on the total amount of the medium. The extruded plastic foil may comprise a dispersion agent, selected from the group of copolymers of ethylene/ethylene acrylate, epoxy resins, polyesters, polyisobutylene, polyamides, polystyrene, acrylic polymers, polyamides, polyimides, melamine, urethane, benzoguanine and phenolic resins, silicone resins, micronized cellulose, fluorinated polymers (PTFE, PVDF inter alia) and micronized wax as filler or mixtures thereof.

Additives

In a particular embodiment the extruded plastic foil comprises an organic or inorganic UV absorber or mixtures thereof for polymer protection. The organic UV absorber may be contained in an amount of from 0.05% to 4.0% by weight, preferably in an amount of from 0.1% to 3% by weight, based on the total amount of the medium.

The organic UV absorber may be selected from the group of triazines, hindered amines (HALS), oxanilides, cyanoacrylates, benzotriazoles and/or benzophenones. The inorganic UV absorber is preferably selected from one or more mineral oxides such as metal oxides, for example from non-aggregated zinc and/or titanium oxides. The mean particle size of the inorganic additive is preferably <100 nm, more preferably <80 nm and most preferably <40 nm.

The entire production process of the Greenhouse foil comprises following main process steps:

a) Manufacturing of the selected inorganic phosphor

b) Extrusion of the masterbatch with Polyethylen and inorganic Phosphor

c) Extrusion the foil with Polyethylen and Masterbatch.

In step a) preferably an inorganic phosphor is processed with enclosed raw materials and process parameters.

Product Name: CZA Formula: Ca₁₄Al₁₀Zn₆O₃₅:Mn⁴⁺

Raw Materials and Weighting

a. Ratio: Ca:Al:Zn:Mn:B:Na=14:9.85:6:0.15 [mol]

b. CaCO₃ 56.346 121 g

c. Al₂O₃ 20.192 094 g

d. ZnO 19.634 246 g

e. MnO₂ 0.52439 22 g

Mixing

The mixture of raw materials is mixed for 15-30 min using a mortar with acetone

Heating

The mixture is put in alumina crucible and heated in a furnace with following condition.

Heating step 1 Heating up to 800° C. in 4 h

Heating step 2 Heating up to 1150° C. in 3.5 h

Heating step 3 Keeping for 6 h

Heating step 4 Cooling down to 800 in 3.5 h (−100° C./h)

Heating step 5 Cooling down to RT

Grinding

The heated samples are grinded with alumina mortar for 5-10 min.

Sieving

The grinded powder is sieved by electromagnetic vibrating sieve.

Sieve size: 63 μm

Qualified Particle Size of Phosphor

The embedded Phosphor in the printable paste, have a particle size variation from 0.5 μm up to 40 μm preferably in a particle size variation from 0.5 μm up to 10 μm.

In step b)

Qualified masterbatch according to the invention contains

1 to 25% by Polyethylene wax

50to 75% by weight of polyolefin resin

0.1 to 40% by weight of inorganic phosphor (e.g. CZO)

0.1 to 6% by weight of Stabilizer based on the mass of the masterbatch.

2.5 Qualified greenhouse foil according to the invention contains 5 to

50% by Masterbatch

50 to 95% by weight of polyolefin resin

In step c)

2.6 Preparation a plastic foil

A double-screw extruder of the ZSK 30 type with screws operating in a synchronized and unidirectional manner was used for mixing. The temperature at the inlet of the extruder was about 120° C., the temperature in the mixing zone about 40° C. and at the outlet about 180° C. The residence time of the material to be homogenized in the extruder was 5 minutes at a pressure of 0.050 to 20 kPa. Subsequently, the material was granulated.

Alternative method for manufacturing of inorganic phosphor comprising Greenhouse foil can be selectively coating of the front and/or backside of the plastic foil with printing technique or completely coating by spray technique, dip technique or doctor blade. Qualified printing methods are Offset-printing, Inkjet-printing (hotmelt), Jet-dispensing (hotmelt) and gravure printing. Particularly suitable printing methods are essentially screen printing with screen separation or stencil printing without separation.
Specification of phosphor for printing application:

The embedded phosphor in the printable paste, have a particle size variation from 0.5 μm up to 15 μm

The applied paste composition may comprise a solvent, selected from the group water, mono- or polyhydric alcohols, such as glycerol, 1,2-propanediol, 1,4-butanediol, 1,3-butanediol, 1,5-pentanediol, 2-ethyl-1-hexenol, ethylene glycol, diethylene glycol and dipropylene glycol, and ethers thereof, such as ethylene glycol monobutyl ether, triethylene glycol monomethyl ether, diethylene glycol monobutyl ether and dipropylene glycol monomethyl ether, and esters, such as [2,2-butoxy(ethoxy)]ethyl acetate, esters of carbonic acid, such as propylene carbonate, ketones, such as acetophenone, methyl-2-hexanone, 2-octanone, 4-hydroxy-4-methyl-2-pentanone and 1-methyl-2-pyrrolidone, as such or in a mixture. In a most preferred embodiment the etching paste comprises 1,4-butandiol as solvent. The solvent may be contained in an amount of from 10 to 90% by weight, preferably in an amount of from 15 to 85% by weight, based on the total amount of the medium.

In a preferred embodiment, the screen printing paste according to the invention has a viscosity in the range of 10 to 500 Pa s, preferably of 50 to 200 Pa·s. The viscosity is the material-dependent component of the frictional resistance which counters movement when adjacent liquid layers are displaced. According to Newton, the shear resistance in a liquid layer between two sliding surfaces arranged parallel and moved relative to one another is proportional to the velocity or shear gradient G. The proportionality factor is a material constant which is known as the dynamic viscosity and has the dimension m Pa·s. In Newtonian liquids, the proportionality factor is pressure- and temperature-dependent. The degree of dependence here is determined by the material composition. Liquids or substances having an inhomogeneous composition have non-Newtonian properties. The viscosity of these substances is additionally dependent on the shear gradient.

Qualified printing layout are complete filled squares or rectangles. The amount of inorganic phosphor can be reduced with line printing of squares or circle layout with 50 um up to 200 um line width or printing of dots with diameter 100 um up to 1 mm.

Irregular spray layout with airbrush system can be used as well.

The applied inkjet composition may comprise a solvent, selected from the group of aliphatic linear and branched ketones such as methyl n-amyl ketone, methyl iso-amyl ketone, methyl hexyl ketone, methyl heptyl ketone, 4-methoxy-4-methyl-2-pentanone, ethyl butyl ketone, ethyl amyl ketone, di-n-propyl ketone, di-iso-butyl ketone, iso-butyl heptyl ketone; cyclic ketones such as lactones (e.g. gamma-butyrolactone, gamma-valerolactone, from esa- to dodeca-lactones) cyclohexanone and its derivatives (methyl cyclohexanone, trimethyl cyclohexanone), N-methyl-2-pyrrolidone and mixtures thereof, other ketones such as methyl heptenone may also be used. Preferably, the high flash-point active solvents are choosen between C₇-C₁₂ aliphatic linear or branched ketones and the family of cyclic ketones as lactones, derivatives of cyclohoxanone and N-methyl-2-pyrrolidone. Most preferably, the high flash-point active solvents are cyclic ketones such as gamma-butyrolactone or 3,3,5-Mmethylcyclohexanone in a concentration within the range of 1% to 25% by weight. The active solvent is selected from ketones having flash-point higher than 40° C., preferably higher than 50° C., and more preferably higher than 60° C. The high solvency power of ketones can offer improved dissolution properties for the binder at lower active solvent concentrations. Suitable active solvents for the blend are aliphatic linear and branched ketones such as methyl n-amyl ketone, methyl iso-amyl ketone, methyl hexyl ketone, methyl heptyl ketone, 4-methoxy-4-methyl-2-pentanone, ethyl butyl ketone, ethyl amyl ketone, di-n-propyl ketone, di-iso-butyl ketone, iso-butyl heptyl ketone; cyclic ketones such as lactones (e.g. gamma-butyrolactone, gamma-valerolactone, from esa- to dodeca-lactones) cyclohexanone and its derivatives (methyl cyclohexanone, trimethyl cyclohexanone), N-methyl-2-pyrrolidone and mixtures thereof, other ketones such as methyl heptenone may also be used. Preferably, the high flash-point active solvents are choosen between C₇-C₁₂ aliphatic linear or branched ketones and the family of cyclic ketones as lactones, derivatives of cyclohoxanone and N-methyl-2-pyrrolidone. Most preferably, the high flash-point active solvents are cyclic ketones such as gamma-butyrolactone or 3,3,5-Mmethylcyclohexanone in a concentration within the range of 1% to 25% by weight.

In terms of greenhouses where substantially only top lighting is applied, optionally in combination with solar light, or substantially based on solar light, the local light receiving area may be the effective plant production area of the base area.

The term “local light receiving area” may in an embodiment refer to a plurality of such areas, for instance a greenhouse with a plurality of rows, with each row having its respective local light receiving area. Hence, a local light receiving area may be divided into two or more subareas. For instance, when more than one sensor may be applied to monitor the local light (intensity and/or spectral distribution), it may be desirable to divide the local light receiving area in more than one or more subareas, respectively (which each subarea being monitored by at least one sensor).

Herein, the term “horticulture production facility” may refer to a greenhouse or an advanced greenhouse with mono-layer production facility (or multi-layer plant factory). Such horticulture production facility may substantially apply daylight as light source and optionally supplemental light, as will in general be the case in greenhouses and advanced greenhouses, or may substantially use artificial light as light source, as will in general be the case in multi-layer facilities.

A greenhouse may thus be seen as a type of single-layer plant factory In yet a further aspect, the invention provides a horticulture production facility comprising a lighting system as defined herein, the lighting system especially comprising a lighting device comprising a plurality of light sources configured within the horticulture production facility, wherein the light sources are configured to illuminate with horticulture light crops within said horticulture production facility, wherein the lighting system further comprises a control unit which is configured to control the light intensity of local light at a location within the horticulture production facility, wherein the local light is the sum of the horticulture light and light at the location originating from an optional other light source, and wherein the control unit is configured to prevent a change in the photosynthetic photon flux density (PPFD) of the local light at the location within the horticulture production facility of on average more than 5 sec/m² (threshold) over a predetermined period of time selected from the range of equal to or smaller than 5 minutes, or even equal to or smaller than 2 minutes, by controlling the contribution of the horticulture light to the local light, wherein the photosynthetic photon flux density (PPFD) is measured in total number of photons (emitted by the lighting device and the optional other light source) per second per unit of a local light receiving area (such as e.g. the effective base area of a greenhouse wherein top lighting is applied).

In yet a further aspect, the invention provides the use of a method of providing horticulture light to a crop in a horticulture production facility comprising providing said horticulture light (for instance from the herein described lighting system) to said crop, wherein when the light intensity of the horticulture light is changed, this change only occurs by gradually increasing or decreasing (the light intensity of the horticulture light) with time.

Surprisingly we did detect the mechanism to change and to control the Red:FarRed (R:FR) ratio by adjustment of transmittance value and fluorescence value by changing selected inorganic Phosphor, concentration of inorganic Phosphor, material of polymer matrix and thickness of the polymer matrix.

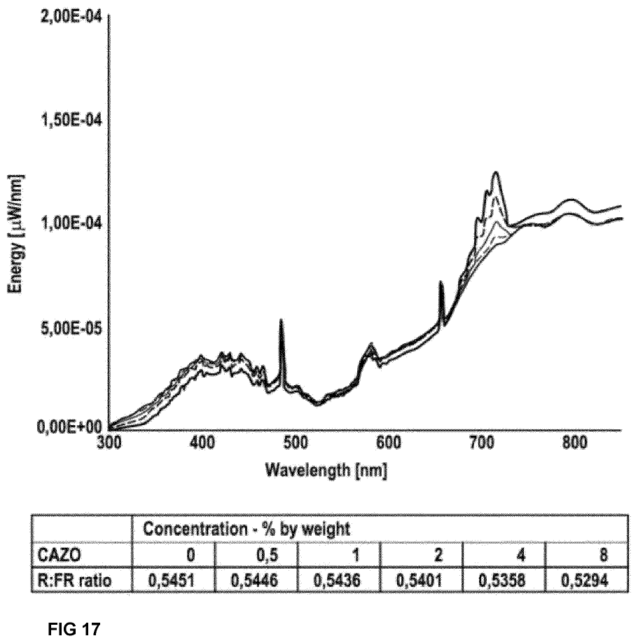

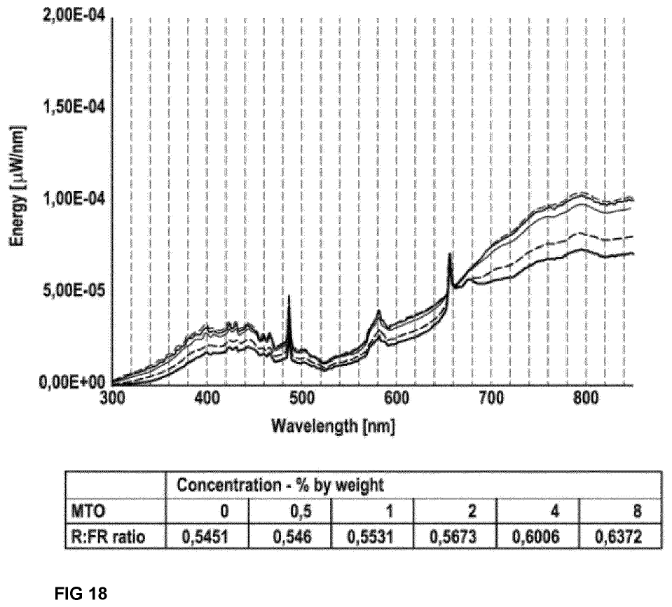

The method of the invention comprising the process steps of:
a. Selection of qualified responding plants for greenhouse cultivation.
b. Measurement of the available light spectrum in the greenhouse from natural sunlight and/or artificial light.
c. Predicting solar photosynthetic active radiation (PAR) during the upcoming time period.
d. Calculating of Red:FarRed (R:FR) ratio for maximum yield increase for responding plants.
e. Selecting inorganic phosphor and/or mixture, concentration of inorganic Phosphor, polymer matrix and thickness of the polymer matrix to adjust the R:FR ratio which determines the ratio between active phytochromes (Pfr) and inactive phytochromes (Pr) with maximum yield increase for predetermined environment.
   Experimental data of light investigation for selected foil material with different concentration of inorganic phosphor to calculate the R:FR ratio is disclosed in FIG. 17 and FIG. 18.

The invention may overcome also the following problems or disadvantages:

1. Plants experience stress when artificial light sources are suddenly turned on and off.

2. In the presence of natural daylight in greenhouse environment, plants experience different light settings as they are on the North or South or East or West side of the greenhouse (cardinal positions). Those light settings differences get higher when artificial light is controlled regardless of daylight changes in intensity.

3. Similarly, LED chips experience stress (e.g., thermal and mechanical stress) at the moment of large current changes, e.g., from 0 mA to 350 mA. The stress is considered to affect the lifetime of the LED chips (and maybe other electronics components as well), and therefore potentially shortens the lifetime of LED lamps or modules. Advantageously, the invention provides a lighting system as well the use of a method to cope with sudden (large) interruptions of light to the crop, by providing supplemental light during such interruption. The invention also provides a lighting system as well as the use of a method to increase or decrease the horticulture light intensity (in terms of PPFD) in a gradual way. The above-mentioned problem(s) may be solved with this lighting system as well as this use of a method, especially in combination with a light sensor and a (remote) controlled lighting system.

If there are no other light sources than those of the lighting device or lighting system, so only horticulture light is provided, then, when changing the horticulture light intensity level this will be controlled to be in only small steps. However, in case there are other sources of light, then light intensity levels may (also) change due to fluctuations in the light of the other light sources, and then the changes in the horticulture light intensity level may be large, to compensate the fluctuations in the light of the other light sources. For instance: a built-in control loop with external set point; if the external set point remains constant, then soft start/stop is omitted, and changes are implemented immediately (for instance a cloud taking away solar light). Alternatively, or in addition, if the external (recipe) set point for a horticulture light module is changed, the built-in control loop may need to perform a soft start/stop adjustment, possibly with a configurable time constant. Hence, with the invention better and/or quicker horticulture products may be obtained in an economic way, as plant stress may be prevented or reduced. Therefore, the term “change” especially relates to one or more of a reduction or increase in intensity due to a reduction respectively increase of the optional light of the optional light source, an increase in intensity due to an increase in the horticulture light intensity and a decrease in intensity due to a decrease in the horticulture light intensity.

The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). The term “crop” is used herein to indicate the horticulture plant that is grown or was grown. Plants of the same kind grown on a large scale for food, clothing, etc., may be called crops. A crop is a non-animal species or variety that is grown to be harvested as e.g. food, livestock fodder, fuel, or for any other economic purpose. The term “crop” may also relate to a plurality of crops. Horticulture crops may especially refer to food crops (tomatoes, peppers, cucumbers and lettuce), as well as to plants (potentially) bearing such crops, such as a tomato plant, a pepper plant, a cucumber plant, etc. Horticulture may herein in general relate to e.g. crop and non-crop plants. Examples of crop plants are Rice, Wheat, Barley, Oats, Chickpea, Pea, Cowpea, Lentil, Green gram, Black gram, Soybean, Common bean, Moth bean, Linseed, Sesame, Khesari, Sunhemp, Chillies, Brinjal, Tomato, Cucumber, Okra, Peanut, Potato, Corn, Pearlmillet, Rye, Alfalfa, Radish, Cabbage, Lettuce, Pepper, Sunflower, Sugarbeet, Castor, Red clover, White clover, Safflower, Spinach, Onion, Garlic, Turnip, Squash, Muskmelon, Watermelon, Cucumber, Pumpkin, Kenaf, Oilpalm, Carrot, Coconut, Papaya, Sugarcane, Coffee, Cocoa, Tea, Apple, Pears, Peaches, Cherries, Grapes, Almond, Strawberries, Pine apple, Banana, Cashew, Irish, Cassava, Taro, Rubber, Sorghum, Cotton, Triticale, Pigeonpea, and Tobacco. Especial of interest are tomato, cucumber, pepper, lettuce, water melon, papaya, apple, pear, peach, cherry, grape, and strawberry.

Horticulture crops may especially be grown in a greenhouse, which is an example of a horticulture production facility (or horticulture factory). Hence, the invention especially relates to the application of the lighting system and/or the (use of the) method in a greenhouse or other horticulture production facility. The lighting device, or more especially the plurality of light sources, may be arranged between plants, or between plants to be, which is referred to as “inter-lighting”. Horticulture growth on wires, like tomato plants, may be a specific field of application for inter-lighting, which application may be addressed with the present device and method. The lighting device, or more especially the plurality of light sources, may also be arranged over the plants or plants to be. Combinations of configurations of light sources, such as in between the crops (inter-lighting) and over the crops, may also be applied. Hence, in embodiments the light sources are configured over the crops, or between the crops, or over and between the crops.

Especially when horticulture crops are grown in layers on top of each other, artificial lighting is necessary. Growing horticulture crops in layers is indicated as “multilayer growth” and may take place in a (multi-layer growth) horticulture production facility. Also, in multi-layer growth horticulture production facility, the lighting system and/or method may be applied.

In embodiments, such horticulture application comprises a plurality of said lighting devices, wherein said lighting devices are optionally configured to illuminate crops within said horticulture production facility. In another embodiment, the horticulture production facility comprises multiple layers for multi-layer crop growth, the horticulture application further comprising a plurality of said lighting devices, configured for lighting the crops in said plurality of layers.

The invention relates to the art of growing plants. More particularly, it relates to a method and greenhouse by which plant growth can be significantly increased by treatment of growing plants.

In the preferred embodiment, the invention consists of properly selecting an inorganic phosphor which, when contacted with either artificial or natural illumination, will give off light that is Luminescent in character and that is formed of predominantly red and blue wave lengths while being reduced in green wave lengths. Luminescent light of predominantly red and blue wave lengths has been proven beneficial to plant growth when directed onto the plant structure and particularly onto its leaves. Many plants, when subjected to such light over a period of time, generally exhibit improved growth or condition in one form or another. In some case the improved growth takes the form of increased flower and/or fruit production by the plant and in other instances is evidenced by increased stature and foliage of the plant.

The invention is advantageously used in connection with a greenhouse type structure provided with a suitable surface upon which the selected Luminescent inorganic phosphor can be disposed for contact with light. In the preferred embodiment, the surface containing the Luminescent colorant is positioned so that it is exposable to sun light and plants within the green house are situated so as to receive the benefits of Luminescent light generated upon contact of the inorganic phosphor by sun light.

The invention is applicable generally to all groups that requires light in order to control condition (such as growing speed) of plants, crops, and prosper.

Light is utilized by the plant in its process of photosynthesis. The preferred embodiment contemplates the use of light having a predominance of such red wavelength, but which also includes some blue wave lengths, together with green wave lengths in which the green wave lengths are in a reduced concentration as compared with the green wave length concentration in the light prior to its contact with the Luminescent colorant. In the broader aspects the invention embraces the use of any concentration of red wave lengths that produces a beneficial effect upon plants. A beneficial effect may be obtained where substantially all of the light which contacts the plant has a wave length above 650 nm.

The degree of improvement will generally be proportionate to the amount of Luminescent light utilized up to the point where the plants ability to use the light is exceeded. Up to the point of light saturation of the plant, where most of the light utilized is of the type herein specified, maximum benefits will be observed. However, less amounts obtained by mixtures of the presently specified type of light and ordinary light will also achieve the advantages of the present invention, although perhaps to less degree.

In carrying out the process, any source of light may be utilized for activating the inorganic phosphor and solutions. Preferably the light source is sun light. The source of light is simply directed into contact with the selected inorganic phosphor, to obtain light of the requisite type. The light so obtained following contact is then directed onto the plants in any suitable manner.

In the experiment to be described hereinafter, exposure of the plants is accomplished in several ways.

In another aspect, the invention relates to a composition comprising, essentially consisting of, or consisting of, at least a light luminescent material and a pigment.

In another aspect, the invention also relates to a foil comprising at least a light luminescent material and a pigment.

In another aspect, the invention further relates to use of the composition comprising, essentially consisting of, or consisting of, at least a light luminescent material and a pigment, or a foil comprising at least a light luminescent material and a pigment for a modulating a condition of a biological cell by light irradiation and heat management in a greenhouse.

In a preferred embodiment, said light luminescent material is a phosphor as described in the section of “Phosphor” above.

More preferably, said phosphor is an inorganic phosphor emitting a radiation in the range between 300-900 nm.

In a preferred embodiment of the present invention, said pigment reflects radiation of 900 nm or longer. Preferably from 1000 nm to 2000 nm.

As the pigments, publicly known pigments can be used preferably(e.g. Iriotec solarfair® pigments by Merck).

It is believed that the phosphor(s) acts mainly on the photoreceptors of the plants and the reflecting pigment(s) are responsible for heat management of the greenhouse for instance.

Thus, said foil may contain light luminescent materials and pigments in one same layer. Or said foil may also contain two or more different sublayers, such as a 1^{st} sublayer and 2^{nd} sublayer, and said light luminescent materials and pigments are in different sublayers of said foil separately such as said light luminescent materials are incorporated in the 1^{st} sublayer and said pigments are included into the 2^{nd} sublayer of the foil each separately.

In case of said light luminescent materials and the pigments are in one same layer, the concentration of the light luminescent material and the concentration of the pigments can be different in the vatical or horizontal direction in the foil.

In some embodiments of the present invention, said composition and foil may include one or more of additives.
Additives for composition and foil (especially for the composition and the foil comprising at least one light luminescent material and a pigment.)

In some embodiments of the present invention, the composition can further comprise at least one additive, preferably the additive is selected from one or more members of the group consisting of photo initiators, co-polymerizable monomers, cross linkable monomers, bromine-containing monomers, sulfur-containing monomers, adjuvants, adhesives, insecticides, insect attractants, yellow dye, pigments, phosphors, metal oxides, Al, Ag, Au, dispersants, surfactants, fungicides, and antimicrobial agents.

In some embodiments of the present invention, the composition can embrace one or more of publicly available vinyl monomers that are co-polymerizable. Such as acrylamide, acetonitrile, diacetone-acrylamide, styrene, and vinyl-toluene or a combination of any of these.

According to the present invention, the composition can further include one or more of publicly available crosslinkable monomers.

For example, cyclopentenyl(meth)acrylates; tetra-hydro furfuryl-(meth)acrylate; benzyl (meth)acrylate; the compounds obtained by reacting a polyhydric alcohol with and α,β-unsaturated carboxylic add, such as polyethylene-glycol di-(meth)acrylates (ethylene numbers are 2-14), tri-methylol propane di(meth)acrylate, tri-methylol propane di (meth)acrylate, tri-methylol propane tri-(meth)acrylate, tri-methylol propane ethoxy tri-(meth) acrylate, tri-methylol propane propoxy tri-(metha) acrylate, tetra-methylol methan tri-(meth) acrylate), tetra-methylol methane tetra(metha) acrylate, polypropylene glycol di(metha)acrylates (propylene number therein are 2-14), Di-penta-erythritol penta(meth)acrylate, di-penta-erythritol hexa(meth)acrylate, bis-phenol-A Polyoxyethylene di-(meth)acrylate, bis-phenol-A dioxyethylene di-(meth)acrylate, bis-phenol-A trioxyethylene di-(meth)acrylate, bis-phenol-A decaoxyethylene di-(meth)acrylate; the compounds obtained from an addition of an α,β-unsaturated carboxylic acid to a compound having glycidyl, such as tri-methylol propane triglycidylether triacrylate, bis-phenol A diglycidylether diacrylates; chemicals having poly-carboxylic adds, such as a phtalic anhydride; or chemicals having hydroxy and ethylenic unsaturated group, such as the esters with hydroxyethyl (meth)acrylate; alkyl-ester of acrylic acid or methacylic acid, such as methyl (meth)acrylate, ethyl (meth)acrylate, butyl (meth)acrylate, 2-ethyl hexyl (meth)acrylate; urethane (meth)acrylate, such as the reactants of Tolylene diisocyanate and 2-hydroxyethyl (meth)acrylate, the reactants of tri-methyl hexamethylene di-isocyanate and cyclohexane dimethanol, and 2-hydroxyethyl (meth)acrylate and a combination of any of these.

In a preferred embodiment of the present invention, the crosslinkable monomer is selected from the group consisting of tri-methylol-propane tri (meth)acrylate, di-pentaerythritol tetra-(meth)acrylate, di-pentaerythritol hexa-(meth)acrylate, bisphenol-A polyoxyethylene dimethacrylate and a combination thereof.

The vinyl monomers and the crosslinkable monomers described above can be used alone or in combination.

From the viewpoint of controlling the refractive index of the composition and/or the refractive index of the color conversion sheet according to the present invention, the composition can further comprise publicly known one or more of bromine-containing monomers, sulfur-containing monomers. The type of bromine and sulfur atom-containing monomers (and polymers containing the same) are not particularly limited and can be used preferably as desired.

For example, as bromine-containing monomers, new frontier® BR-31, new Frontier® BR-30, new Frontier® BR-42M (available from DAI-ICHI KOGYO SEIYAKU CO., LTD) or a combination of any of these, as the sulfur-containing monomer composition, IU-L2000, IU-L3000, IU-MS1010 (available from MITSUBISHI GAS CHEMICAL COMPANY, INC.) or a combination of any of these, can be used preferably.

In a preferred embodiment of the present invention, the photo initiator can be a photo initiator that can generates a free radical when it is exposed to an ultraviolet light or a visible light. For example, benzoin-methyl-ether, benzoin-ethyl-ether, benzoin-propyl-ether, benzoin-isobutyl-ether, benzoin-phenyl-ether, benzoin-ethers, benzophenone, N,N′-tetramethyl-4,4′-diaminobenzophenone (Michler's-ketone), N,N′-tetraethyl-4,4′diaminobenzophenone, benzophenones, benzil-dimethyl-ketal (Ciba specialty chemicals, IRGACURE® 651), benzil-diethyl-ketal, dibenzil ketals, 2,2-dimethoxy-2-phenylacetophenone, p-tert-butyldichloro acetophenone, p-dimethylamino acetophenone, acetophenones, 2,4-dimetyl thioxanthone, 2,4-diisopropyl thioxanthone, thioxanthones, hydroxy cyclohexyl phenyl ketone (Ciba specialty chemicals, IRGACURE® 184), 1-(4-isopropylphenyl)-2-hydroxy-2-methylpropane-1-on (Merck, Darocure® 1116), 2-hydroxy-2-methyl-1-phenylpropane-1-on (Merck, Darocure® 1173).

An adjuvant can enhance permeability of effective component (e.g. insecticide), inhibit precipitation of solute in the composition, or decrease a phytotoxicity. Here, a surfactant means it does not comprise or is not comprised by other additives, for example a spreading agent, a surface treatment and an adjuvant.

Preferably said adjuvant can be selected from the group consisting of a mineral oil, an oil of vegetable or animal origin, alkyl esters of such oils or mixtures of such oils and oil derivatives, and combination thereof.

As one embodiment, the weight ratio of each 1 additive of dispersant, surfactant, fungicide, antimicrobial agent and antifungal agent, to the weight of the invention phosphor in the total amount of the composition is in the range from 50 wt. % to 200 wt. %, more preferably it is from 75 wt. % to 150 wt. %. Exemplified embodiment of an adjuvant is Approach BI (Trademark, Kao Corp.).

Said composition may also include polymer material.

The invention is illustrated in the Figures.

FIG. 1 shows a greenhouse covered with a foil (1) consisting of LDPE that consists of one layer, which contains inorganic phosphor as light converting material.

FIG. 2 shows plant-tunnel with a foil (1) consisting of LDPE that consists of one layer, which contains inorganic phosphor as light converting material inside a glass-greenhouse (3).

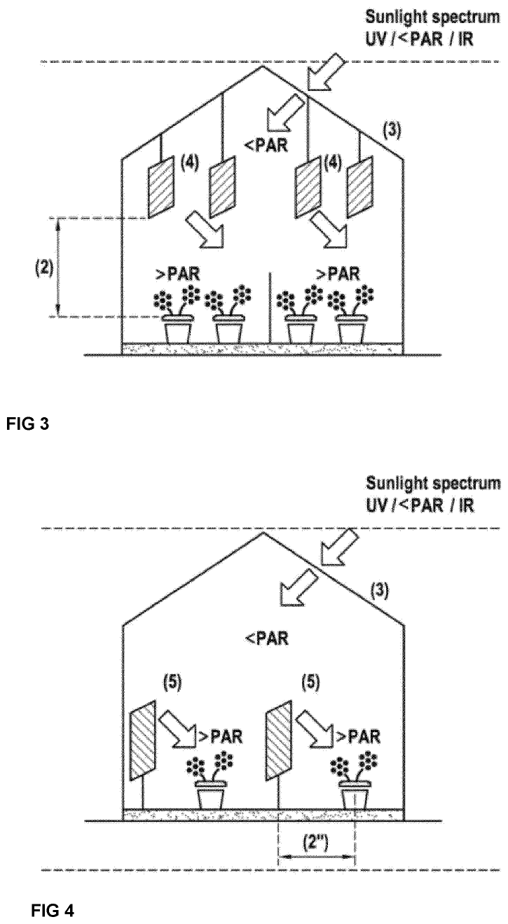

FIG. 3 shows a glass-greenhouse (3) with ceiling mounted light reflection with curtains (4) consisting of LDPE foil and/or fabric that consists of one layer, which contains inorganic phosphor as light converting material.

FIG. 4 shows a glass-greenhouse (3) with bottom fixed vertical light reflection-shields (5) consisting of LDPE foil that consists of one layer, which contains inorganic phosphor as light converting material.

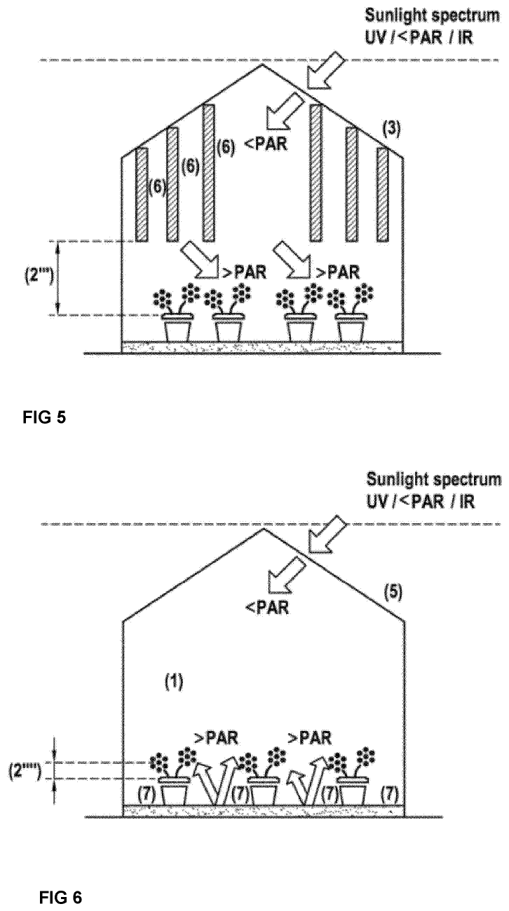

FIG. 5 shows a glass-greenhouse (3) with ceiling mounted light reflection-tapes (6) consisting of LDPE foil that consists of one layer, which contains inorganic phosphor as light converting material.

FIG. 6 shows a glass-greenhouse (3) with bottom fixed horizontal light reflection-tapes or fabric (7) consisting of LDPE foil that consists of one layer, which contains inorganic phosphor as light converting material.

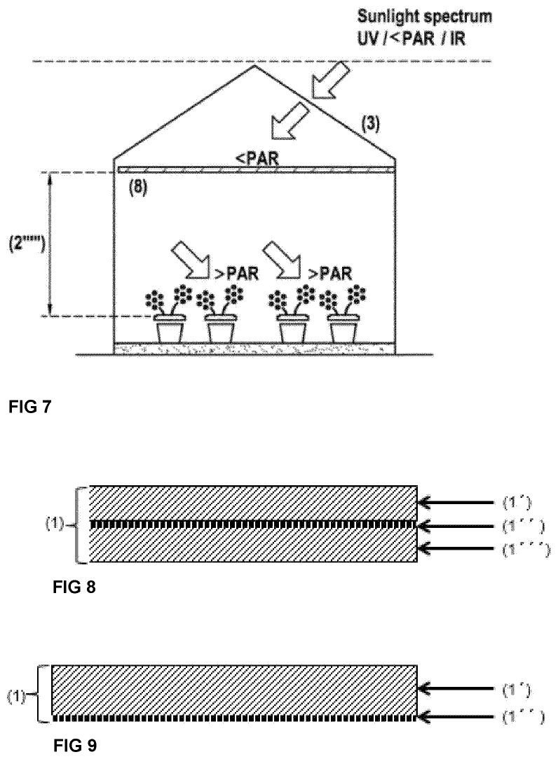

FIG. 7 shows a glass-greenhouse (3) with horizontal light reflection-foil or fabric (8) as suspended ceiling consisting of LDPE foil that consists of one layer, which contains inorganic phosphor as light converting material

FIG. 8 shows a greenhouse foil (1) consisting of a light converting layer (1″) that is covered on both sides with support layers (1′) and (1′″) which not contain inorganic phosphor as light converting material and that are transparent.

FIG. 9 shows a greenhouse foil (1) consisting of a light converting layer (1″) that is coated on the bottom side of the support layers (1′) which does not contain inorganic phosphor as light converting material and this is transparent.

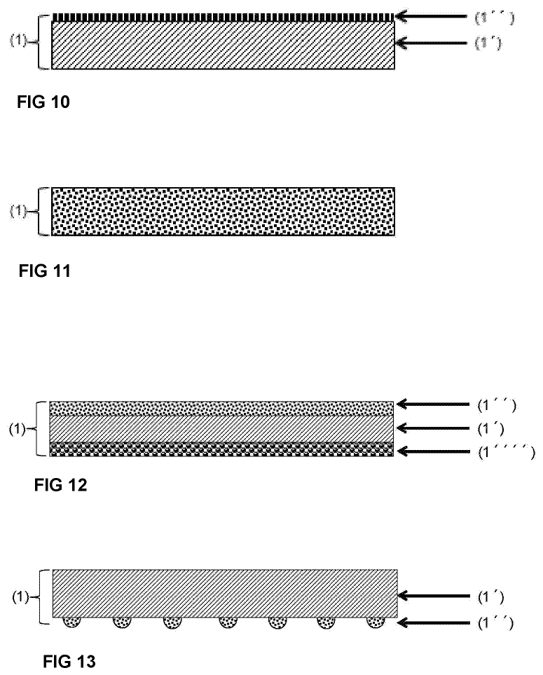

FIG. 10 shows a greenhouse foil (1) consisting of a light converting layer (1″) that is coated on the front side of the support layers (1′) which does not contain inorganic phosphor as light converting material and this is transparent.

FIG. 11 shows a greenhouse foil (1) consisting of a light converting layer (1″) which does contain inorganic phosphor as light converting material.

FIG. 12 shows a greenhouse foil (1) consisting of a transparent support layer (1′) which not contain inorganic phosphor as light converting material that is covered on both sides with different light converting layers (1′), (1″″) which contain different inorganic Phosphor.

FIG. 13 shows a greenhouse foil (1) consisting of a light converting layer (1″) that is selected coated or printed on the front side of the support layers (1′) which does not contain inorganic phosphor as light converting material and this is transparent.

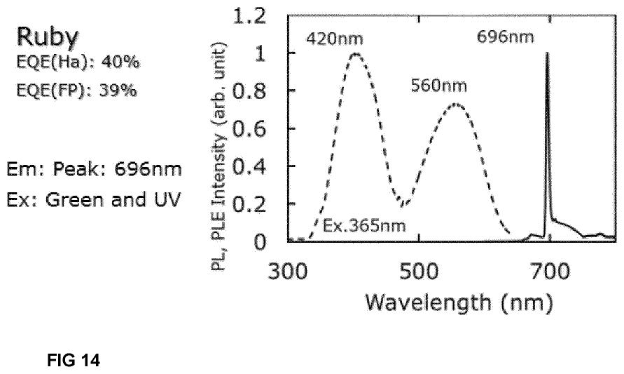

FIG. 14 shows the light spectrum for excitation and emission of the light converting material Ruby. Excitation of Ruby can be performed at 420 nm and 560 nm. The resulting peak maximum light wavelength of the red-light emission is 696 nm.

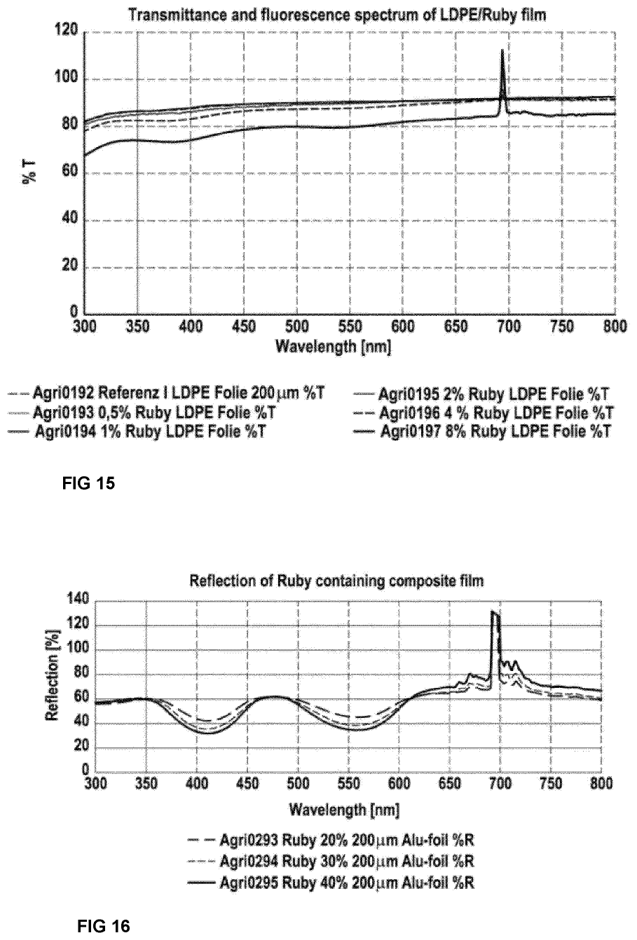

FIG. 15 shows the resulting transmittance and fluorescence light spectrum of 5 Polyethylene foil samples (1) with a standard thickness of 200 micron with different concentration of inorganic phosphor—Ruby.

FIG. 16 shows the resulting reflection light spectrum of 3 Reflection sheet samples (4) with a standard thickness of 200 micron with different concentration of inorganic phosphor—Ruby

FIG. 17 shows the resulting transmittance and fluorescence energy spectrum of 5 Polyethylene foil samples (1) with a standard thickness of 200 micron with different concentration of inorganic phosphor—CAZO and the table with calculated R:FR ratio.

FIG. 18 shows the resulting transmittance and fluorescence energy spectrum of 5 Polyethylene foil samples (1) with a standard thickness of 200 micron with different concentration of inorganic phosphor—MTO and the table with calculated R:FR ratio.

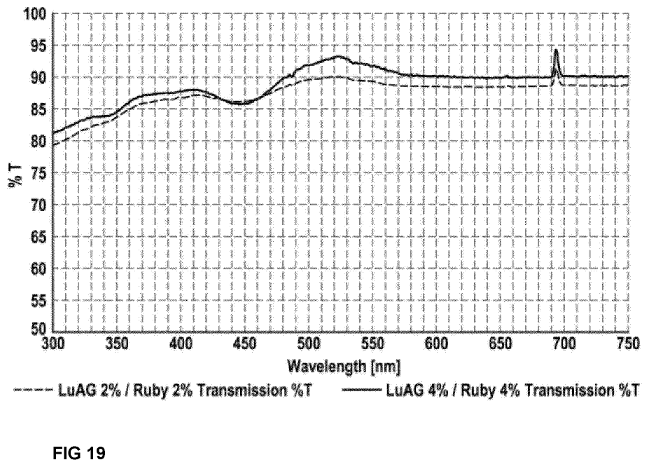

FIG. 19 shows the resulting transmittance and fluorescence light spectrum of 4 silicon foil samples (1) with a standard thickness of 180 micron with 2 different inorganic phosphor materials—Ruby with chemical formula (Al2O3:Cr) and LuAG with chemical formula (Lu3Al5O12:Ce).

### PREFERABLE EMBODIMENTS

1. Method for modulating a condition of a biological cell by light irradiation from a light luminescent material, preferably said light luminescent material is an inorganic phosphor, with a light source, preferably the light source is sunlight and/or an artificial light source,

wherein the modulating a condition of a biological cell is archived by applying light irradiation of light emitted from said light luminescent material comprising the peak maximum light wavelength in the range from 500 nm to 750 nm,

wherein the light emitted from the light luminescent material is obtained by contacting the light from the light source with the light luminescent material which is incorporated in or onto a polymer and/or glass matrix for manufacturing of film, sheets and pipes.

In a preferred embodiment, the biological cell is a cell of a living organism, more preferably biological cell is a prokaryotic or eukaryotic cell, particularly preferably, the prokaryotic cell is a bacterium or archaea, particularly preferably, the eukaryotic cell is a plant cell, animal cell, fungi cell, slime mould cell, protozoa cell and algae, very particularly preferably the biological cell is a plant cell, most preferably the biological cell is a crop cell or a flower cell.

2. Method modulating a condition of a biological cell by light irradiation with a light source comprising process steps of:

A. Selecting a biological cell for greenhouse cultivation, preferably, the biological cell is a cell of a living organism, more preferably biological cell is a prokaryotic or eukaryotic cell, particularly preferably, the prokaryotic cell is a bacterium or archaea, particularly preferably, the eukaryotic cell is a plant cell, animal cell, fungi cell, slime mould cell, protozoa cell and algae, very particularly preferably the biological cell is a plant cell, most preferably the biological cell is a crop cell or a flower cell;

B. Measurement of the available light spectrum and intention of the light spectrum in the greenhouse from natural sunlight and/or artificial light;

C. Predicting the integrated amount of solar radiation which can modulate a condition of a biological cell during the cultivation, preferably said radiation includes a peak light wavelength in the range from 600 nm or more;

D. Calculating of Red:FarRed (R:FR) ratio for maximum yield increase for responding a biological cell;

E. Selecting a light luminescent material and/or mixture, concentration of the light luminescent material, polymer matrix and thickness of the polymer matrix to adjust the R:FR ratio which determines the ratio between active phytochromes (Pfr) and inactive phytochromes (Pr) with maximum yield increase for predetermined environment.

3. The method of claim 1 or 2, wherein the light luminescent material is selected so that the light emitted from light luminescent material, obtained by contacting the light from the light source with light luminescent material which is incorporated in or onto a polymer and/or glass matrix for manufacturing of film, sheets and pipes for cultivation of a biological cell, contains the light wavelength at 600 nm or above.

Preferably said light luminescent material is an inorganic phosphor.

4. The method of any one of embodiments 1 to 3, wherein the light luminescent material and/or mixture is selected so that the light obtained by contact of emitted light form a light source therewith, is formed predominantly of wavelengths from 500 nm to 550 nm and 650 nm to 750 nm.

5. The method of any one of embodiments 1 to 3, wherein the light luminescent material is selected so that the light obtained by contact of emitted light form a light source therewith includes intensity of light in blue wavelengths, preferably said blue wavelength is in the range from 400 nm to 470 nm.

6. The method according to any one of embodiments 1 to 5, wherein one or more light luminescent material is selected so that the light obtained by contact of emitted light form a light source therewith includes blue and red wavelengths in the light emission spectrum, preferably said blue wavelength is in the range from 400 to 470 nm and said red wavelength is in the range from 650 to 750 nm.

7. The method according to any one of embodiments 1 to 6, wherein two or more different light luminescent material materials selected so that the light spectrum of red wavelength and/or green and/or blue wavelength is broadened or intensified in the light emission spectrum of light emitted from a light source.

8. A method according to any one of embodiments 1 to 7, wherein the composite layer (1) supported by a matrix layer containing light luminescent material (1) exposure of the growing plants is executed by emitting and reflecting fluorescent light onto the plants.

9. A method according to any one of embodiments 1 to 8, wherein said light luminescent material including layer (1) comprising at least one light luminescent material including particles or mixtures thereof in amounts of from 0.2% to 40% by weight, based on the total amount of the matrix layer composition.

Preferably, said light luminescent material including layer (1) is an inorganic phosphor including layer.

10. A method according to any one of embodiments 1 to 9, said light luminescent material including layer (1) comprising a light luminescent material or mixtures of light luminescent materials with particle size (d90) from 1 um to 20 um.

11. A method according to any one of embodiments 1 to 10, wherein said light source is sunlight and/or additional high-pressure sodium light and/or LED light to activate the matrix layer with light luminescent material (1) to generate the desired fluorescence spectrum.

12. A foil comprising a polymeric substrate and at least one compound incorporated in the polymeric substrate or coated on the polymeric substrate, wherein the compound is one or more of light luminescent materials in a concentration of 0.5% to about 35% by weight, based on the total weight of the polymeric substrate.

Preferably, said light luminescent material is an inorganic phosphor.

13. A composite layer (1) usable as greenhouse foil comprising a supporting layer (1′) and at least one light luminescent material layer (1″), preferably said layer (1″) comprises at least one light luminescent material. Preferably, said light luminescent material is an inorganic phosphor. Preferably said light luminescent material layer (1″) is an inorganic phosphor layer.

14. The composite layer (1) usable as greenhouse foil of embodiment 13, characterized in that the layer that contains at least one light luminescent material (1″) layer, preferably, said layer (1″) comprises at least one light luminescent material that is covered on both sides with support layers (1′), (1′″), preferably said support layer comprises, or consists of a plastic material.

15. Composite layer (1) usable as greenhouse foil according to embodiment 13 or 14, characterized in that the layer contains at least one layer (1″) comprising at least one light luminescent material, wherein one or more light luminescent material is distributed within a plastic material.

16. A greenhouse for modulating a condition of a biological cell by light irradiation from a light luminescent material having at least one light luminescent material matrix layer (1) as active material for generating intensified wave lengths above 600 nm in the fluorescence spectrum. Preferably, said light luminescent material is an inorganic phosphor.

17. A greenhouse according to embodiment 16 for modulating a condition of a biological cell by light irradiation from a light luminescent material, having at least one light luminescent material matrix layer (1) as active material for accelerating plant grows comprising the significant parameters, wherein

a) Thickness of plastic material between 100 um and 250 um

b) Distance (2) of a biological cell to light luminescent material matrix layer 1 cm or more,

wherein a plastic material is selected as a matrix material for the light luminescent material matrix layer (1).

18. A greenhouse of embodiment 16 or 17, characterized in that the plastic material of the composite layer (1) is selected from one or more members of the group consisting of polyethylene (PE), polypropylene (PP), polyvinylchloride (PVC), polystyrol (PS), polytetrafluorethylene (PTFE), poly(methyl methacrylate) (PMMA), polyacrylnitril (PAN), polyacrylamid (PAA), polyamide (PA), aramide (polyaramide), (PPTA, Kevlar®, Twaron®), poly(m-phenylen terephthalamid) (PMPI, Nomex®, Teijinconex®), polyketons like polyetherketon (PEK), polyethylene terephthalate (PET, PETE), polycarbonate (PC), polyethylenglycol (PEG), polyurethane (PU), Kapton K and Kapton HN is poly (4,4′-oxydiphenylene-pyromellitimide), Poly(organo)siloxane and Melamine-resin (MF).

19. A process for manufacture of a thermoplastic foil or sheet comprising at least one light luminescent material comprising the process steps;

i) providing a light luminescent material powder comprising at least one light luminescent material, preferably said light luminescent material is an inorganic phosphor,

ii) Extrusion of the Masterbatch with Polyethylengranule with the light luminescent material powder, and

iii) Extrusion of the foil with Polyethylen and Masterbatchgranule. Preferably, said light luminescent material is an inorganic phosphor.

20. A process of embodiment 19, characterized in that the composite layer (1) contains copolymers selected from one or more members of the group consisting of ethylene/ethylene acrylate, epoxy resins, polyesters, polyisobutylene, polyamides, polystyrene, acrylic polymers, polyamides, polyimides, melamine, urethane, benzoguanine and phenolic resins, silicone resins, micronized cellulose, fluorinated polymers (PTFE, PVDF inter alia) and micronized wax as filler.

Effect of the Invention

The phosphor of the present invention does not have degrading performance under the environment of high temperature, high humidity, UV light, and can be used as an LED artificial light source without additional energy from the grid. Also, the phosphor of the present invention can realize optimal environment for modulating a condition of a biological cell.

Smart use of sun-light activated phosphor foil can achieve energy savings of up to 50%.

### WORKING EXAMPLES

### Example 1

### Production of an Inorganic Phosphor Containing Reflection Foil (4) or (5)

Materials Used

2 g of Aerosil 200

5 g of Vinnol 18/38

63 g of Butyl acetat

30 g of Ruby

Vinnol is dissolved in the initially introduced solvent Butyl acetate and stirred well. Aerosil and Ruby is subsequently stirred in, and a homogeneous paste is prepared. The paste is applied to a polyester film having a thickness of 5-250 μm, preferably 30 μm, using screenprinting and dried.

### Example 2

### Production of an Inorganic Phosphor Containing Reflection Fabric (4) or (5)

Materials Used

2 g of Aerosil 200

5 g of Vinnol 18/38

260 g of Butyl acetat

30 g of Ruby

Vinnol is dissolved in the initially introduced solvent Butyl acetate and stirred well. Aerosil and Ruby are subsequently stirred in, and a homogeneous and low viscous solution is prepared. The solution is sprayed to a fabric (Tempa 5557 from Svensson) having a thickness of 5-25 μm, preferred 10 μm, using airbrush system and dried.

### Example 3

### Production of an Inorganic Phosphor Containing Transmittance Foil (1)

Materials Used

95 g of Butyl acetate

16 g of PVB (polyvinylbutyral, Pioloform,Wacker)

11 g Vestosint 2070

3 g Aerosil 200

50 g of Ruby

PVB is dissolved in the initially introduced solvent Butyl acetate and stirred well. Aerosil, Vestosint and Ruby are subsequently stirred in, and a homogeneous paste is prepared. The paste is applied to a LDPE film having a thickness of 50-250 μm, preferably 80 μm, using screen printing and dried.

The hot lamination of the coated film with non-coated film can be carried out, for example, at about 140° C. (FIG. 8).

### Example 4

### Working Example

### Comparative Example 1

A large plant growth-promoting sheet without phosphor having 50 μm layer thickness is made from Petrothene180 (Trademark, Tosoh Corporation) as a polymer with using a Kneading machine and inflation moulding machine. Then all plant seedlings of Boston lettuce are covered by the sheet and it is exposed to light from an artificial LED lighting having peak wavelength from 550-600 nm for 16 days. Finally, their fresh weight is measured.

### Comparative Example 2

A large plant growth-promoting sheet without phosphor having 50 μm layer thickness is made in the same manner as described in comparative example1.

Then all plant seedlings of Boston lettuce are covered by the sheet and it is exposed to sunlight for 16 days. Finally, their fresh weight is measured.

### Example 5

### Synthesis of Mg₂TiO₄:Mn⁴⁺

The phosphor precursors of Mg₂TiO₄:Mn⁴⁺ are synthesized by a conventional solid-state reaction. The raw materials of magnesium oxide, titanium oxide and manganese oxide are prepared with a stoichiometric molar ratio of 2.000:0.999:0.001. The chemicals are put in a mixer and mixed by a pestle for 30 minutes. The resultant materials are oxidized by firing at 1000° C. for 3 hours in air.

To confirm the structure of the resultant materials, XRD measurements are performed using an X-ray diffractometer (RIGAKU RAD-RC). Photoluminescence (PL) spectra is measured by using a Spectro-fluorometer (JASCO FP-6500) at room temperature. The photoluminescence excitation spectrum shows a UV region from 300-400 nm while the emission spectrum exhibited a deep red region from 660-670 nm.

### Example 6

### Working Example with Composition 1

20 g of Mg₂TiO₄:Mn⁴⁺ phosphor from synthesis example 1 and 0.6 g of siloxane compound (SH 1107, manufactured by Toray Dow Corning Co., Ltd.) are put in a Waring blender, these and mixed at a low speed for 2 minutes.

After uniformly surface-treating in this process, the resultant materials are heat-treated in an oven at 140° C. for 90 minutes.

Then, final surface treated Mg₂TiO₄:Mn⁴⁺ phosphors with aligned particle sizes are acquired by shaking with a stainless screen with an opening of 63 μm.

The agricultural material is prepared using Mg₂TiO₄:Mn⁴⁺ as a phosphor, and Petrothene180 (Trademark, Tosoh Corporation) as a polymer. 2 wt % of Mg₂TiO₄:Mn⁴⁺ phosphors in the polymer is mixed to get Composition 1.

### Example 7

### Working Example with Foil

Composition 1 is provided into a Kneading machine and inflation-moulding machine then, a large plant growth-promoting sheet having 50 μm layer thickness is formed.

Then all plant seedlings of Boston lettuce are covered by the sheet and it is exposed to light from artificial LED lighting for 16 days. Finally, their fresh weight is measured.

The present invention demonstrated a fresh weight increase from 20.23 g to 22.34 g in the plants under the growth-promoting sheet compared to the sheet of comparative example 1. The height of the plant from working example 2 is taller than the height of the plant from comparative example 1. The leaves of the plant from working example 2 are bigger, and the color of the plant leaves from working example 2 is deeper green than the leaves of the plant from comparative example 1.

Instead of measuring a weight of a plant, the leaves area of 1 plant can be measured by known method and device. A leaf area meter can be used to measure it. One embodiment is a L13000C Area Meter (Li-COR Corp.). The leaves area can be measured by separating all leaves from 1 plant body, getting a photo image or scan each 1 leaf, and processing these images.

### Example 8

### Synthesis Example 2

### Synthesis of CaMgSi₂O₆:Eu²⁺, Mn²⁺

CaCl₂.2H₂O (0.0200 mol, Merck), SiO₂ (0.05 mol, Merck), EuCl₃.6H₂O (0.0050 mol, Auer-Remy), MnCl₂.4H₂O (0.0050 mol, Merck), and MgCl₂.4H₂O (0.0200 mol, Merck) are dissolved in deionized water. NH₄HCO₃ (0.5 mol, Merck) is dissolved separately in deionized water. The two aqueous solutions are simultaneously stirred into deionized water. The combined solution is heated to 90° C. and evaporated to dryness.

Then, the residue is annealed at 1000° C. for 4 hours under an oxidative atmosphere, and the resulting oxide material is annealed at 1000° C. for 4 hours under a reductive atmosphere.

To confirm the structure of the resultant materials, XRD measurements are performed using an X-ray diffractometer (RIGAKU RAD-RC).

Photoluminescence (PL) spectra is measured using a spectro-fluorometer (JASCO FP-6500) at room temperature. The photoluminescence excitation spectrum of CaMgSi₂O₆:Eu²⁺, Mn²⁺ shows a UV region from 300 to 400 nm while the emission spectrum exhibited in a deep red region from 660 to 670 nm.

The advantage of CaMgSi₂O₆:Eu²⁺, Mn²⁺ is less toxicity, environment friendly and can emit light having peak light wavelength around 660 nm-670 nm which is more useful for plant growth than a red-light emission of a conventional phosphor having peak light emission less than 650 nm.

### Example 9

### Working Example with Composition 2

20 g of CaMgSi₂O₆:Eu²⁺, Mn²⁺ phosphor from working example 1 and 0.6 g of siloxane compound (SH 1107, manufactured by Toray Dow Corning Co., Ltd.) are put in a Waring blender, and mixed at low speed for 2 minutes. After uniformly surface-treating in this process, the resultant materials are heat-treated in an oven at 140° C. for 90 minutes. Then, final surface treated CaMgSi₂O₆:Eu²⁺, Mn²⁺ phosphors with aligned particle sizes are acquired by shaking with a stainless screen with an opening of 63 μm. The agricultural material is prepared using CaMgSi₂O₆:Eu²⁺, Mn²⁺ as a phosphor, and Petrothene180 (Trademark, Tosoh Corporation) as a polymer.

2 wt % of CaMgSi₂O₆:Eu²⁺, Mn²⁺ phosphors in the polymer is mixed to get Composition 2.

### Example 10

### Working Example with Foil

Composition 2 is provided into a Kneading machine and inflation-moulding machine then, a large plant growth-promoting sheet having 50 μm layer thickness is formed.

Then all plant seedlings of Boston lettuce are covered by the sheet and it is exposed to sunlight for 16 days. Finally, their fresh weight is measured. The present invention demonstrated a weight increase from 21.45 g to 23.81 g in the plants under the growth-promoting sheet compared to the sheet of comparative example 2. From agricultural point of view, it is a significant improvement. The height of the plant from working example 4 is taller than the height of the plant from comparative example 2. The leaves of the plant from example 4 are bigger, and the color of the plant leaves from example 4 is deeper green than the leaves of the plant from comparative example 2.

### Example 11

### Synthesis Example 3

### Synthesis of Ba₂YTaO₆:Mn⁴⁺

The present example refers to the synthesis of the phosphor Ba₂YTaO₆:Mn⁴⁺ with a Mn concentration of 1 mol %. The phosphor is prepared according to conventional solid-state reaction methods, using Ba₂CO₃, Y₂O₃, Ta₂O₅ and MnO₂ as starting materials. These chemicals are mixed according to their stoichiometric ratio and mixed with acetone in an agate mortar.

The powder thus obtained is pelletized at 10 MPa, placed into an alumina container and heated at 1400° C. for 6 hours in the presence of air. After cooling the residue is well grinded for characterization. For confirmation of the structure, XRD measurements are performed using an X-ray diffractometer. Photoluminescence (PL) spectra is taken using a Spectro fluorometer at room temperature.

The XRD patterns proofs that the main phase of the product consisted of Ba2YTaO6. The photoluminescence excitation spectrum shows a UV region from 300 to 400 nm while the emission spectrum exhibits a deep red region from 630 to 710 nm.

The absorption peak wavelengths of Ba₂YTaO₆:Mn⁴⁺ is 310-340 nm, and the emission peak wavelength is in the range from 680 to 700 nm.

### Example 12

### Synthesis Example 4

### Synthesis of NaLaMgWO₆:Mn⁴⁺

The present example refers to the synthesis of the phosphor NaLaMgWO₆:Mn⁴⁺ with a Mn concentration of 1 mol %. The phosphor is prepared according to conventional solid-state reaction methods, using Na₂CO₃, La₂O₃, MgO, WO₃ and MnO₂ as starting materials. La₂O₃ is preheated at 1200° C. for 10 hours in the presence of air. The chemicals are mixed according to their stoichiometric ratio and mixed with acetone in an agate mortar.

The powder thus obtained is pelletized at 10 MPa, placed into an alumina container and heated at 1300° C. for 6 hours in the presence of air. After cooling the residue is well grinded for characterization. For confirmation of the structure, XRD measurements are performed using an X-ray diffractometer. Photoluminescence (PL) spectra are taken using a spectro-fluorometer at room temperature.

The XRD patterns proofs that the main phase of the product consisted of NaLaMgWO₆. The photoluminescence excitation spectrum shows a UV region from 300-400 nm while the emission spectrum exhibited a deep red region from 660-750 nm.

The absorption peak wavelengths of NaLaMgWO₆:Mn⁴⁺ is 310-330 nm, and the emission peak wavelength is in the range from 690-720 nm.

### Example 13

### Synthesis Example 5

### Synthesis of Si₅P₆O₂₅:Mn⁴⁺

The present example refers to the preparation of the phosphor Si₅P₆O₂₅:Mn⁴⁺ with an Mn concentration of 0.5 mol %. The phosphor has been prepared according to conventional solid-state reaction methods, using SiO2, NH₄H₂PO₄ and MnO₂ as starting materials. The educts are mixed according to their stoichiometric ratio and mixed with acetone in an agate mortar. The powder thus obtained is pelletized at 10 MPa, placed into an alumina container, pre-heated 300° C. for 6 hours. The pre-heated powder is grinded, pelletized at 10 MPa, placed again in an alumina container and heated at 1,000° C. for another 12 hours in the presence of air. After cooling the residue is well grinded for characterization. For confirmation of the structure, XRD measurements are performed using an X-ray diffractometer. Photoluminescence (PL) spectra are taken using a Spectro fluorometer at room temperature. The XRD patterns proofed that the main phase of the product consisted of Si₅P₆O₂₅.

The photoluminescence excitation spectrum showed a UV region from 300 nm to 400 nm while the emission spectrum exhibited a deep red region at 690 nm.

### Example 14

### Synthesis Example 5

### Synthesis of Y₂MgTiO₆:Mn⁴⁺

In a typical synthesis of Y₂MgTiO₆:Mn⁴⁺, the phosphors precursors were synthesized by a conventional polymerized complex method. The raw materials of yttrium oxide, magnesium oxide, titanium oxide and manganese oxide were prepared with a stoichiometric molar ratio of 2.000:1.000:0.999:0.001. The chemicals were put in a mortar and mixed by a pestle for 30 minutes. The resultant materials were oxidized by firing at 1500° C. for 6 hours in air.

To confirm the structure of the resultant materials, XRD measurements were performed using an X-ray diffractometer (RIGAKU RAD-RC). Photoluminescence (PL) spectra were measured using a spectro-fluorometer (JASCO FP-6500) at room temperature.

### Example 15

### Working Example with Plants

2 wt % of Y₂MgTiO₆:Mn⁴⁺ phosphors aqueous solutions with polyvinyl alcohol is prepared. The solution is set on the polyester film having a thickness of 50 μm by airbrush system. The foil which is set the polymer dots with phosphors on the foil was created. These experiments were conducted in a greenhouse under natural light (sun light) and the resultant agricultural foils is used as lining material of green house for agriculture.

Then all plant seedlings of Radish are covered by the foil and it is exposed to light from artificial LED lighting for 21 days. Finally, their fresh stem weight is measured. The present invention demonstrated a fresh stem weight increase from 7.65 g to 8.91 g in the plants under the growth-promoting foil compared to the foil of comparative example.

| | Plants with foil + | Plants with foil |
|---|---|---|
| Process of weighing | phosphor | (Reference) |
| Fresh weight | 7.65 g | 4.43 g |
| Dried weight | 8.91 g | 3.92 g |

1. Method for modulating a condition of a biological cell by light irradiation from a light luminescent material with a light source, preferably the light source is sunlight and/or an artificial light source,
wherein the modulating a condition of a biological cell is archived by applying light irradiation of light emitted from said light luminescent material comprising the peak maximum light wavelength in the range from 500 nm to 750 nm,
wherein the light emitted from the light luminescent material is obtained by contacting the light from the light source with the light luminescent material which is incorporated in or onto a polymer and/or glass matrix for manufacturing of film, sheets and pipes.

2. Method modulating a condition of a biological cell by light irradiation with a light source comprising process steps of:
A. Selecting a biological cell for greenhouse cultivation, preferably, the biological cell is a cell of a living organism, more preferably biological cell is a prokaryotic or eukaryotic cell, particularly preferably, the prokaryotic cell is a bacterium or archaea, particularly preferably, the eukaryotic cell is a plant cell, animal cell, fungi cell, slime mould cell, protozoa cell and algae, very particularly preferably the biological cell is a plant cell, most preferably the biological cell is a crop cell or a flower cell;
B. Measurement of the available light spectrum and intention of the light spectrum in the greenhouse from natural sunlight and/or artificial light;
C. Predicting the integrated amount of solar radiation which can modulate a condition of a biological cell during the cultivation, preferably said radiation includes a peak light wavelength in the range from 600 nm or more;
D. Calculating of Red:FarRed (R:FR) ratio for maximum yield increase for responding a biological cell;
E. Selecting a light luminescent material and/or mixture, concentration of the light luminescent material, polymer matrix and thickness of the polymer matrix to adjust the R:FR ratio which determines the ratio between active phytochromes (Pfr) and inactive phytochromes (Pr) with maximum yield increase for predetermined environment.

3. The method of claim 1, wherein the light luminescent material is selected so that the light emitted from light luminescent material, obtained by contacting the light from the light source with light luminescent material which is incorporated in or onto a polymer and/or glass matrix for manufacturing of film, sheets and pipes for cultivation of a biological cell, contains the light wavelength at 600 nm or above.

4. The method of claim 1, wherein the light luminescent material and/or mixture is selected so that the light obtained by contact of emitted light form a light source therewith, is formed predominantly of wavelengths from 500 nm to 550 nm and 650 nm to 750 nm.

5. The method of claim 1, wherein the light luminescent material is selected so that the light obtained by contact of emitted light form a light source therewith includes intensity of light in blue wavelengths, preferably said blue wavelength is in the range from 400 nm to 470 nm.

6. The method according to claim 1, wherein one or more light luminescent material is selected so that the light obtained by contact of emitted light form a light source therewith includes blue and red wavelengths in the light emission spectrum, preferably said blue wavelength is in the range from 400 to 470 nm and said red wavelength is in the range from 650 to 750 nm.

7. The method according to claim 1, wherein two or more different light luminescent material materials selected so that the light spectrum of red wavelength and/or green and/or blue wavelength is broadened or intensified in the light emission spectrum of light emitted from a light source.

8. A method according to claim 1, wherein the composite layer (1) supported by a matrix layer containing light luminescent material (1′) exposure of the growing plants is executed by emitting and reflecting fluorescent light onto the plants.

9. A method according to claim 1, wherein said light luminescent material including layer (1) comprising at least one light luminescent material including particles or mixtures thereof in amounts of from 0.2% to 40% by weight, based on the total amount of the matrix layer composition.

10. A method according to claim 1, said light luminescent material including layer (1) comprising a light luminescent material or mixtures of light luminescent materials with particle size (d90) from 1 um to 20 um.

11. A method according to claim 1, wherein said light source is sunlight and/or additional high-pressure sodium light and/or LED light to activate the matrix layer with light luminescent material (1) to generate the desired fluorescence spectrum.

12. A foil comprising a polymeric substrate and at least one compound incorporated in the polymeric substrate or coated on the polymeric substrate, wherein the compound is one or more of light luminescent materials in a concentration of 0.5% to about 35% by weight, based on the total weight of the polymeric substrate.

13. A composite layer (1) usable as greenhouse foil comprising a supporting layer (1′) and at least one light luminescent material layer (1″), preferably said layer (1″) comprises at least one light luminescent material.

14. The composite layer (1) usable as greenhouse foil of claim 13, characterized in that the layer that contains at least one light luminescent material (1″) layer, preferably, said layer (1″) comprises at least one light luminescent material that is covered on both sides with support layers (1′), (1′″), preferably said support layer comprises, or consists of a plastic material.

15. Composite layer (1) usable as greenhouse foil according to claim 13, characterized in that the layer contains at least one layer (1″) comprising at least one light luminescent material, wherein one or more light luminescent material is distributed within a plastic material.

16. A greenhouse for modulating a condition of a biological cell by light irradiation from a light luminescent material having at least one light luminescent material matrix layer (1) as active material for generating intensified wave lengths above 600 nm in the fluorescence spectrum.

17. A greenhouse according claim 16 for modulating a condition of a biological cell by light irradiation from a light luminescent material, having at least one light luminescent material matrix layer (1) as active material for accelerating plant grows comprising the significant parameters, wherein
a) Thickness of plastic material between 100 um and 250 um
b) Distance (2) of a biological cell to light luminescent material matrix layer 1 cm or more,
wherein a plastic material is selected as a matrix material for the light luminescent material matrix layer (1).

18. A greenhouse according claim 16, characterized in that the plastic material of the composite layer (1) is selected from one or more members of the group consisting of polyethylene (PE), polypropylene (PP), polyvinylchloride (PVC), polystyrol (PS), polytetrafluorethylene (PTFE), poly(methyl methacrylate) (PMMA), polyacrylnitril (PAN), polyacrylamid (PAA), polyamide (PA), aramide (polyaramide), (PPTA, Kevlar®, Twaron®), poly(m-phenylen terephthalamid) (PMPI, Nomex®, Teijinconex®), polyketons like polyetherketon (PEK), polyethylene terephthalate (PET, PETE), polycarbonate (PC), polyethylenglycol (PEG), polyurethane (PU), Kapton K and Kapton HN is poly (4,4′-oxydiphenylene-pyromellitimide), Poly(organo)siloxane and Melamine-resin (MF).

19. A process for manufacture of a thermoplastic foil or sheet comprising at least one light luminescent material comprising the process steps;
i) providing a light luminescent material powder comprising at least one light luminescent material, preferably said light luminescent material is an inorganic phosphor,
ii) Extrusion of the Masterbatch with Polyethylengranule with the light luminescent material powder, and
iii) Extrusion of the foil with Polyethylen and Masterbatchgranule.

20. A process of claim 19, characterized in that the composite layer (1) contains copolymers selected from one or more members of the group consisting of ethylene/ethylene acrylate, epoxy resins, polyesters, polyisobutylene, polyamides, polystyrene, acrylic polymers, polyamides, polyimides, melamine, urethane, benzoguanine and phenolic resins, silicone resins, micronized cellulose, fluorinated polymers (PTFE, PVDF inter alia) and micronized wax as filler.
